(19) United States
(12) Patent Application Publication
(10) Pub. No.: US 2021/0046397 A1
(43) Pub. Date: Feb. 18, 2021

(54) EVAPORATOR FOR AMBIENT WATER BODIES, AND RELATED SYSTEM AND METHOD

(71) Applicant: Resource West, Inc., Grand Junction, CO (US)

(72) Inventors: Robert Ballantyne, Clifton, CO (US); William MacDonald, Grand Junction, CO (US)

(21) Appl. No.: 17/046,991

(22) PCT Filed: Apr. 12, 2019
(86) PCT No.: PCT/US19/27391

§ 371 Date: Oct. 12, 2020

Related U.S. Application Data
(60) Provisional application No. 62/656,906, filed on Apr. 12, 2018.
(60) Provisional application No. 62/656,887, filed on Apr. 12, 2018.
(60) Provisional application No. 62/656,856, filed on Apr. 12, 2018.

(51) Int. Cl. B01D 1/20; B01D 1/00; C02F 1/12; C02F 1/04

(52) U.S. Cl. CPC B01D 1/20; B01D 1/007; C02F 2103/007; C02F 1/048; C02F 1/12

(57) ABSTRACT

An evaporator is provided for evaporating water from an ambient water body. The evaporator includes a housing that in turn includes an air flow channel and an air flow exit. The evaporator also includes an air flow induction device, such as a fan or impeller, that facilitates the directing of an air flow stream through the air flow channel and out the air flow exit. A water injection device is in fluid communication with the air flow channel and is disposed to inject the water from the water body into the air flow stream at a water injection location within the air flow stream and proximate to the air flow exit. A water injection system for injecting water from an ambient water body into an air flow stream directed by an air flow channel of an evaporator also is disclosed, wherein the air flow channel is disposed about a longitudinal axis. The water injection system includes an elongated tubular member disposed parallel with respect to the longitudinal axis, a plurality of water injection nodes disposed at the tubular member and spaced from one another longitudinally, and a support for positioning the elongated tubular member within or proximate to the air flow channel so that the plurality of water injection nodes are positioned within the air flow stream.

### CROSS-REFERENCES TO RELATED APPLICATIONS

This application claims priority and the benefit of earlier filing date to U.S. Provisional Application No. 62/656,856, No. 62/656,887, and No. 62/656,906, all of which were filed on Apr. 12, 2018. The entire contents of each of these patent applications are hereby expressly incorporated herein by reference in their entirety as if fully set forth herein, including without limitation the specification or disclosure, claims, abstract, and all drawings, figures and tables thereof.

### FIELD OF THE INVENTION

The present invention relates to evaporators and related components, systems and methods for evaporating water from an ambient body of water, for example, such a pond, lake or the like. This includes artificial water bodies, for example, as are commonly used in industrial applications such as oil and gas exploration, mining, waste water management, and the like.

### BACKGROUND OF THE INVENTION AND RELATED ART

There are many applications in which it is desirable or necessary to evaporate or dispose of water, often in substantial quantities, from an ambient water body, for example, such as a pond, lake, river, impoundment pond, flooded area, or the like. In a significant number of those applications, the water has some form of impurity that precludes simple disposition in another water body, such as a river or stream. Impoundment ponds associated with an oil and gas drilling operations are examples. These ponds often contain high levels of dissolved solids or ions, possibly various forms of hydrocarbons, and other components that could be undesirable or deleterious to the environment if released.

A commonly-used approach for disposing of the water in these water bodies involves physically transporting the water to a disposal site, such as an authorized injection well. Another approach that has been used involves evaporation. In this approach, the water is evaporated into the surrounding air so that the water itself evaporates but the impurities are left behind. Natural evaporation is of limited utility because the evaporation rate usually is unworkably slow. Evaporation devices have been employed that actively facilitate and speed up the evaporation process, for example, by spraying the water into the air, or by entraining the water as droplets in a forced air stream directed above the water body. Evaporators that have been commercially available in recent years from the present assignee, Resource West, Inc., provide examples.

Although this approach has met with substantial success, it is limited in some applications in that it can result in relatively low evaporation rates and relatively low evaporation efficiencies. It also can yield relatively limited water and air mixing. In some cases, bulk-phase water, such as relatively large water droplets, fall out of the plume generated by some known evaporator designs.

### SUMMARY OF THE INVENTION

To address these limitations and to advance the art, and in accordance with the purposes of the invention as embodied and broadly described herein, an evaporator is provided for evaporating water from an ambient water body. The evaporator comprises a housing comprising an air flow channel and an air flow exit, an air flow induction device that facilitates the directing of an air flow stream through the air flow channel and out the air flow exit, and a water injection device in fluid communication with the air flow channel and disposed to inject the water from the water body into the air flow stream at a water injection location within the air flow stream and proximate to the air flow exit.

The water injection device may comprise a range of devices that are capable of injecting water into the air flow stream as such injection is described herein, but preferably comprises one or more nozzles, one or more atomizers, one or more water slingers, or the like.

The water injection location or locations preferably are disposed proximate to the air flow exit. It or they may be at a location or locations at the air flow exit, upstream of the air flow exit, (i.e., within the air flow channel, downstream of the air flow exit, or combinations of these.

In embodiments for which the air flow exit lies in a plane that is perpendicular to the longitudinal axis, these locational or regional descriptions apply literally. In embodiments for which the air flow exit does not lie in such an orthogonal plane, an approximation of the orthogonal plane may be used, for example, such as the most upstream point of the air flow exit, the most downstream point of the air flow exit, or some intermediate point, for example and preferably, at an average or median longitudinal location.

The radial positioning of the water injection location within the air flow stream also may vary. A presently-preferred radial location comprises at or on the longitudinal axis, but the location or locations also may be spaced radially from the longitudinal axis, instead of or in addition to one or more longitudinal locations. If the air flow channel is assumed to comprise an air flow exit having a radius R normal to the longitudinal axis, the radially spaced location may be spaced only slightly off the longitudinal axis, i.e., greater than 0% and at radial locations extending to just before the interior wall of the air flow channel, just less that radius R. Preferably the radial location or locations are sufficiently far from the air flow channel wall the viscous or fluid drag effects associated with the wall are avoided. Although this boundary or zone will vary from application to application, preferably the radial location or locations will be between the longitudinal axis and about 75% of the radius R relative to the longitudinal axis.

Where a water injection device or devices are disposed downstream of the air flow exit, the radius used for this analysis instead of the radial distance to the air flow channel interior wall, (given that there will be no air flow channel at these locations downstream of the air flow channel), may be the boundary between the air flow stream on the one hand and the exterior ambient air around that air flow stream. As the air flow stream proceeds downstream, the surrounding air will be increasingly carried along via the air flow stream and its viscous effects and the boundary between the two will become less differentiated with downstream distance. In embodiments and applications, however, the water injection devices that are positioned downstream of the air flow exit are not so far downstream that at least a rough boundary cannot be discerned. For an evaporator with a 42-inch diameter fan casing, for example, one normally would not position water injection devices more than a few feet downstream, although this is not necessarily limiting. In situations where water injection devices are positioned downstream of the air flow exit, as a rule of thumb and as an optional but preferred location selection, the radial location or locations will be between the longitudinal axis and between about 50% and 75% of the radius r_{D} of this expanding boundary relative to (and normal with respect to) the longitudinal axis.

The radial location, locations or region of water injection devices also may be based on the flow characteristics of the air flow stream as well. The air flow stream, for example, has an air flow velocity profile, typically as a function of the air flow channel radius where the air flow channel is generally cylindrical or symmetrical about the longitudinal axis, and the air flow velocity profile normally will have a maximum velocity location, again, typically at a particular radius or radial region of the profile. The water injection location or locations accordingly may be disposed at this maximum velocity location, which typically will be a range of locations at or about a particular radial distance from the longitudinal axis. Similarly, the water injection location or locations may lie within a region lying between the longitudinal axis and the maximum velocity location.

The radial locations or locations also may be at a fixed geometric location or range of locations, for example, such as where the water injection location or locations are disposed at a midpoint between the longitudinal axis and a wall of the air flow channel

For a given water injection device or node, the direction in which the water injection device actually injects the water into the air flow stream also may vary. The water injection device or devices may be configured, for example, to inject the water into the air flow stream in the downstream direction, e.g., along the longitudinal axis with the air flow stream, parallel to the longitudinal axis, or in a direction with a downstream directional component parallel to the longitudinal axis. Similarly, the water injection device or devices may be configured to inject the water into the air flow stream in the upstream direction, e.g., along the longitudinal axis and counter to the air flow stream, parallel to the longitudinal axis, or in a direction with an upstream directional component parallel to the longitudinal axis. The water injection device or devices also may be positioned to cause the water to be injected radially outward, e.g., along a plane that is perpendicular to the longitudinal axis, or with a radial component. The water injection device also may be configured to inject the water into the air flow stream tangentially with respect to a radius lying in a plane perpendicular with respect to the longitudinal axis.

A single water injection device may be used, but preferably there is a plurality of water injection devices or nodes, and there is a plurality of water injection locations. Preferably, the respective water injection locations are spaced from one another. The spacing may be longitudinal, radial, and combinations of these. In some presently-preferred embodiments, the water injection locations are spaced from one another along the longitudinal axis. They also may be spaced from one another in a radial plane orthogonal with respect to the longitudinal axis, or in a plurality of such radial planes.

In some presently-preferred embodiments, in which there is a plurality of water injection devices, a first set of the plurality of water injection devices injects water in a first principal direction, and a second set of the plurality of water injection devices injects water in a second principal direction. Although their specific configurations may vary, the first principal direction preferably has an angle of about 30 to 90 degrees with respect to the second principal direction.

In some embodiments, the plurality of water injection devices comprises n water injection devices disposed longitudinally, where n is a variable that may assume an integer value greater than 1, and each of the n water injection devices comprises a principal direction, and for each adjacent pair of the water injection devices, the principal directions has an angular separation of at least 30 degrees.

The water injection devices also may be configured as water injection nodes, where each node comprises between two and five water injection devices, and where the number of nodes n is between two and fifty. The longitudinal and radial spacing between nodes need not be uniform, but preferably is either uniform or substantially so. In a presently-preferred embodiment, for example, the longitudinal spacing with respect to an adjacent one of the water injection devices of at least 1.5 inches.

The relative positioning of the water injection devices or nodes preferably is selected so that the water spray or injection pattern or adjacent devices does not overlap, or at least does not substantially or unduly overlap. In some embodiments, the air flow exit has a radius r with respect to an air flow exit plane that is orthogonal with respect to the longitudinal axis, where the radius r is measured from the longitudinal axis to an interior surface of the air flow exit, each of the principal directions lies in one of a plurality of radial planes, each of the radial planes being parallel to the air flow exit radial plane and corresponding to one of the n water injection devices, and each of the water injection devices emits water in a conical spray cone geometry centered at the principal direction for the water injection device and having a conical angle of between about 10 and 90 degrees so that each of the water injection devices emits water in a conical volume consisting essentially of a volume within the conical angle lying between the longitudinal axis and the interior wall of the air flow channel.

In some embodiments, the plurality of water injection locations comprises paired water injection locations disposed so that the water injection from one of the paired water injection locations does not overlap with the water injection from the other of the paired water injection locations. Similarly, the paired water injection locations may be spaced from one another along the longitudinal axis.

In presently-preferred embodiments, the air flow induction device comprises an impeller disposed in the housing. Such evaporators also preferably comprise a plurality of guide vanes disposed in the housing downstream with respect to the impeller that reduce non-longitudinal flow in the air flow stream.

In accordance with another aspect of the invention, a method is provided for evaporating water from an ambient body of water using an evaporator comprising an air flow channel and an air flow exit. The method comprises directing an air flow stream through the air flow channel and out the air flow exit, and injecting the water into the air flow stream at one or more water injection locations within the air flow stream proximate to the air flow exit.

Although not necessarily limiting, injection of the water into the air flow stream at the one or more water injection locations may be achieved using the water injection devices, nodes and locations described herein. This includes without limitation the location or positioning of the water injection devices and nodes, their orientation, and so on, as described herein above and as further described herein below.

In this method, the provision of an air stream through the air flow channel preferably comprises using an impeller that comprises, or more preferably consists essentially of, a fiberglass material. It also preferably comprises reducing non-longitudinal air flow within the air flow channel, for example, using a plurality of guide vanes disposed within the air flow channel.

In accordance with another aspect of the invention, a water injection system is provided for injecting water from an ambient water body into an air flow stream directed by an air flow channel of an evaporator. For purposes of illustration and reference, the air flow channel is assumed to be disposed about a longitudinal axis. The water injection system comprises an elongated tubular member disposed parallel with respect to the longitudinal axis, a plurality of water injection nodes disposed at the tubular member and being spaced from one another longitudinally, and a support for positioning the elongated tubular member within or proximate to the air flow channel so that the plurality of water injection nodes are positioned within the air flow stream.

The tubular member optionally but preferably is linear or substantially linear, and is configured to be disposed at the longitudinal axis of the air flow channel. This tubular member preferably comprises a pipe or pipe like device capable of allowing the passage of fluid along the length of the longitudinal axis from a flow source such as a pump to water injection devices or nodes, such as nozzles, atomizers, water slings and the like.

The water injection devices and nodes may be sized and configured, together with the fluid pressure applied to the water that emanates from them, to create water droplets of selected or predetermined size range.

In accordance with a related aspect of the invention, a water injection system is provided for injecting water from an ambient water body into an air flow stream directed by an evaporator comprising a housing that includes an air flow channel and an air flow exit disposed about a longitudinal axis, wherein the air flow channel directs the air flow stream through the air flow channel and out the air flow exit in a downstream direction. The water injection system comprises an elongated manifold disposed along the longitudinal axis within the air flow stream, and a plurality of water injection nodes disposed at the manifold. The water injection nodes are spaced from one another in the downstream direction, and each of the water injection nodes comprises at least one water injection device that injects the water into the air flow stream at a water injection location within the air flow stream proximate to the air flow exit.

In accordance with another aspect of the invention, an evaporator is provided for evaporating water from an ambient water body. The evaporator comprises a housing that includes an air flow channel and an air flow exit disposed about a longitudinal axis. The air flow channel provides an air flow stream through the air flow channel and out the air flow exit in a downstream direction. The evaporator also comprises a water injection system that injects the water into the air flow stream. The water injection system comprises an elongated manifold disposed along the longitudinal axis within the air flow stream, and a plurality of water injection nodes disposed at the manifold. The water injection nodes are spaced from one another in the downstream direction. Each water injection node comprises at least one water injection device that injects the water into the air flow stream at a water injection location within the air flow stream proximate to the air flow exit.

The water injection devices preferably are disposed proximate to the longitudinal axis. Optionally but preferably, the water injection devices are disposed substantially at the elongated manifold. In a presently-preferred embodiment, the water injection devices are disposed substantially along or at the longitudinal axis. In some embodiments, the air flow stream has a toroidal velocity profile comprising a center region disposed about the longitudinal axis, and the water injection devices are disposed within the center region.

In some embodiments, each water injection node lies in a radial plane, and the water injection devices inject water into the air flow stream along the radial plane. In some embodiments, each of the water injection nodes comprises two water injection devices lying in a radial plane orthogonal with respect to the longitudinal axis, each of the water injection devices injecting the water into the air flow stream along the radial plane. A first one of the water injection devices injects the water in a first direction and a second one of the water injection devices injects the water in a second direction that is 180 degrees from the first direction.

In some embodiments, each of the water injection nodes comprises three water injection devices lying in a radial plane orthogonal with respect to the longitudinal axis. Each of the water injection devices injects the water into the air flow stream along the radial plane, each of the water injection devices injects the water in a principal direction, and the each of the principal directions is 120 degrees from the other two principal directions.

In some embodiments, each of the water injection nodes comprises four water injection devices lying in a radial plane orthogonal with respect to the longitudinal axis. Each of the water injection devices injects the water into the air flow stream along the radial plane, each of the water injection devices injects the water in a principal direction, and the each of the principal directions is 90 degrees from each of two adjacent principal directions.

In some embodiments, the plurality of water injection nodes comprises n water injection nodes disposed longitudinally, where n is a variable that may assume an integer value greater than 1, and each of the n water injection devices comprises a principal direction. For each adjacent pair of the water injection devices, the principal direction has an angular separation of at least 30 degrees. Optionally but preferably, there are between two and five water injection devices per node and there are between two and fifty nodes.

Preferably, each of the water injection devices comprises a longitudinal spacing with respect to an adjacent one of the water injection devices of some minimum distance, for example, in certain presently-preferred embodiments, of at least 1.5 inches.

### BRIEF DESCRIPTION OF THE DRAWINGS

The accompanying drawings, which are incorporated in and constitute an integral part of the specification, illustrate presently-preferred embodiments and methods of the invention and, together with the general description given above and the detailed description of the preferred embodiments and methods given below, serve to explain the principles of the invention. Of the drawings:

FIG. 1 is a perspective view of an impoundment pond at which two evaporators according to various aspects of the invention are located and operating;

FIG. 2 is a perspective view of an evaporator according to a presently-preferred embodiment of an aspect of the invention;

FIG. 3 is a side cutaway view of the evaporator of FIG. 2;

FIG. 4 is a graphical depiction of an illustrative air flow velocity profile for air flow in and downstream of the evaporator of FIGS. 2 and 3 based on a side view of the evaporator;

FIG. 5 is a graphical depiction of the air flow velocity profile of FIG. 6 based on an end or longitudinal view of the evaporator;

FIG. 6 is another graphical depiction of an air flow velocity profile for the air flow of an evaporator, and is used to explain the operation of the evaporator of FIGS. 2 and 3 based on a side view of the evaporator;

FIG. 7 is a graphical depiction of the air flow velocity profile of FIG. 6, based on an end or longitudinal view of the evaporator;

FIG. 8 is a longitudinal view of portions of a water injection system for use in the evaporator of FIGS. 2 and 3;

FIG. 9 is a side cutaway view of the water injection system of FIG. 8;

FIG. 10 is a side schematic of the evaporator of FIGS. 2 and 3 that shows an illustrative air flow stream and plume downstream of the evaporator;

FIG. 11 is a side view of a nozzle used in the evaporator of FIGS. 2 and 3;

FIG. 12 is an end or longitudinal view of the nozzle of FIG. 11;

FIG. 13 is a perspective view of the nozzle of FIG. 11;

FIG. 14 is a longitudinal view of a portion of another water injection system for use in the evaporator of FIGS. 2 and 3;

FIG. 15 is a side view of the water injection system portions of FIG. 14;

FIG. 16 is a longitudinal view of a portion of another water injection system for use in the evaporator of FIGS. 2 and 3;

FIG. 17 is a side view of the water injection system portions of FIG. 16;

FIG. 18 is a perspective view of a portion of still another water injection system for use in the evaporator of FIGS. 2 and 3;

FIG. 19 is an enlarged side view of the downstream end of the water injection system of FIG. 18;

FIG. 20 is a longitudinal view of the water injection system of FIG. 18;

FIG. 21 is a side cutaway view of an evaporator according to another presently-preferred embodiment of an aspect of the invention;

FIG. 22 is a longitudinal view of an inlet grille used in the evaporator of FIG. 21;

FIG. 23 is a side view of a portion of the housing for the evaporator of FIG. 21, and illustrates an air gap in the housing;

FIG. 24 is an exploded side view of the housing portion shown in FIG. 23;

FIG. 25 is a side view of the assembled housing portion shown in FIGS. 23 and 24;

FIG. 26 is a perspective view of an impeller used in the evaporator of FIG. 23;

FIG. 27 is a longitudinal view from the upstream side of the fan casing of the evaporator of FIG. 2 including the impeller of FIG. 26;

FIG. 28 is a perspective view from the downstream end of the fan casing of FIG. 27, and illustrates guide vanes;

FIG. 29 is a schematic side view of an evaporator such as that of FIG. 21, used to described benefits of certain features of aspects of the invention;

FIG. 30 is a schematic side view similar to FIG. 29, also used to describe benefits of certain features of aspects of the invention;

FIG. 31 is a graphical depiction of an illustrative air flow velocity profile for air flow in the evaporator of FIG. 21 based on a side view of the evaporator;

FIG. 32 is a graphical depiction of the illustrative air flow velocity profile of FIG. 31 based on an end or longitudinal view of the evaporator;

FIG. 33 is a perspective view of an evaporator according to another presently-preferred embodiment of an aspect of the invention;

FIG. 34 is a side cutaway view of the evaporator of FIG. 22;

FIG. 35 is a perspective view of a water injection system according to a presently-preferred embodiment of another aspect of the invention for use in an evaporator;

FIG. 36 is a side view of the water injection system of FIG. 35;

FIG. 37 is an end view of the water injection system of FIG. 35; and

FIG. 38 is a graphical depiction of the nozzle arrangement for the water injection system of FIG. 35 according to an end or longitudinal view.

### DETAILED DESCRIPTION OF THE PREFERRED EMBODIMENTS AND METHODS

Reference will now be made in detail to the presently-preferred embodiments and methods of the invention as illustrated in the accompanying drawings, in which like reference characters designate like or corresponding parts throughout the drawings. It should be noted, however, that the invention in its broader aspects is not limited to the specific details, representative devices and methods and illustrative examples shown and described in this section in connection with the preferred embodiments and methods. The invention according to its various aspects is particularly pointed out and distinctly claimed in the attached claims read in view of this specification, and appropriate equivalents.

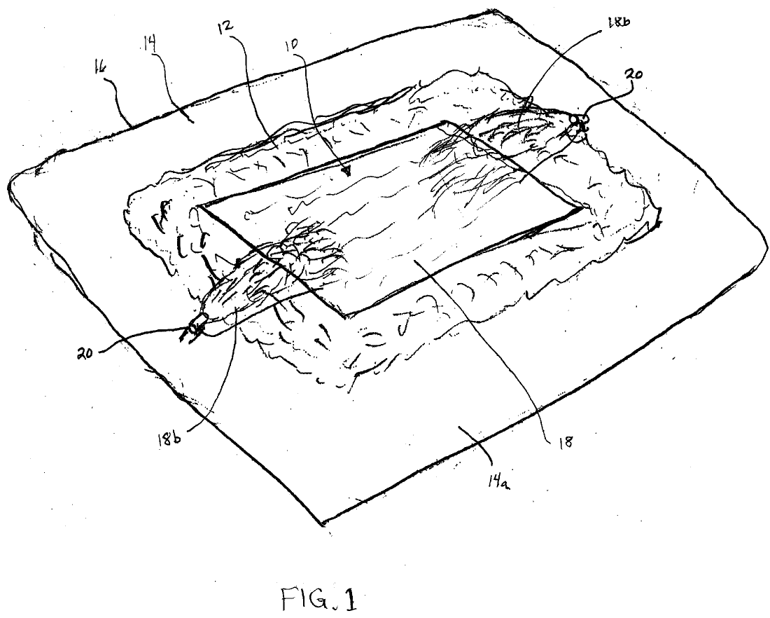

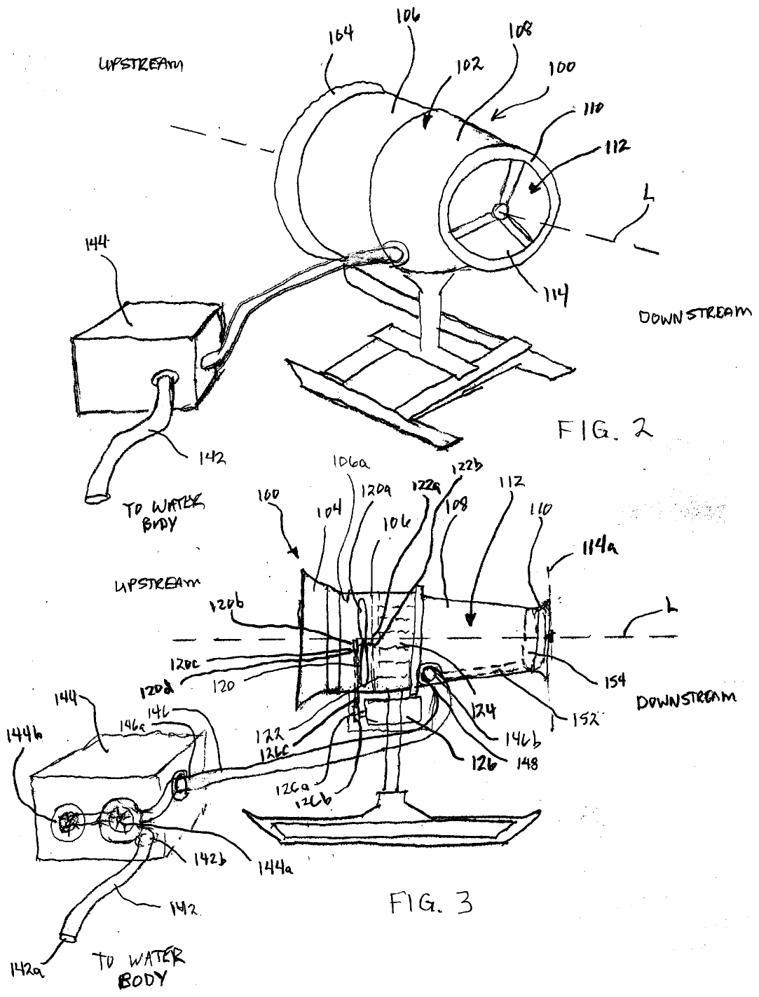

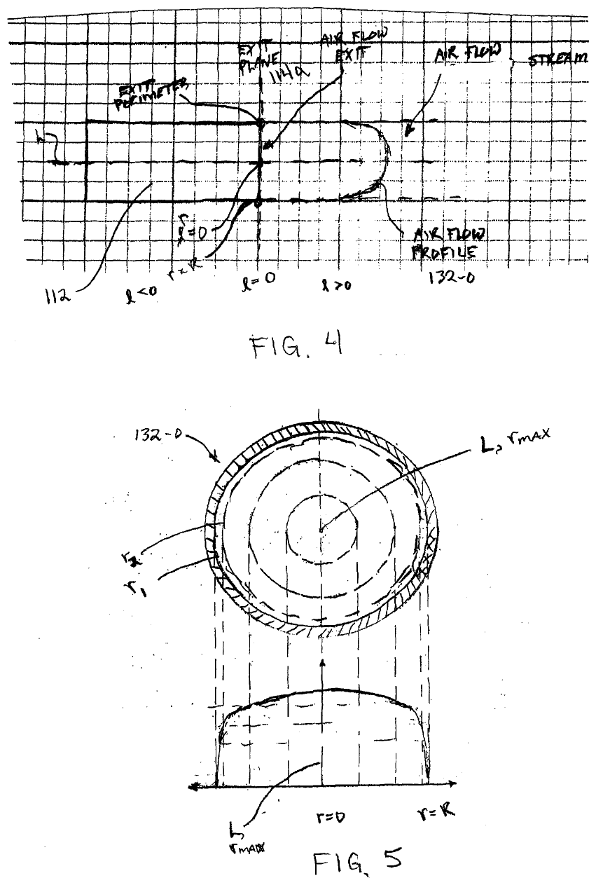

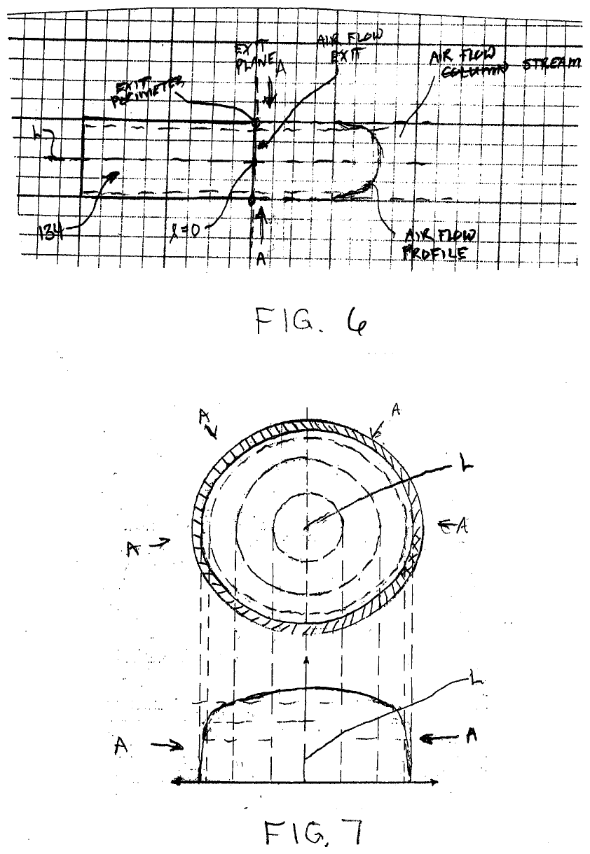

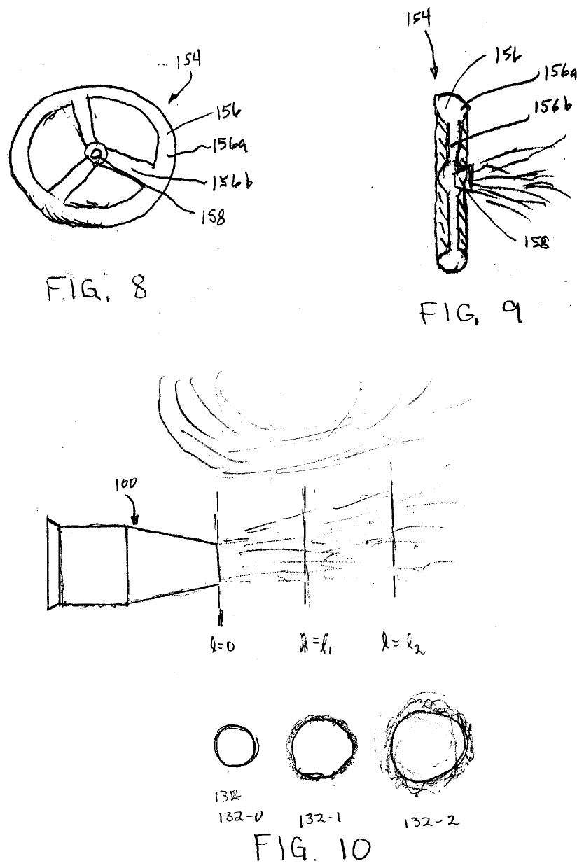

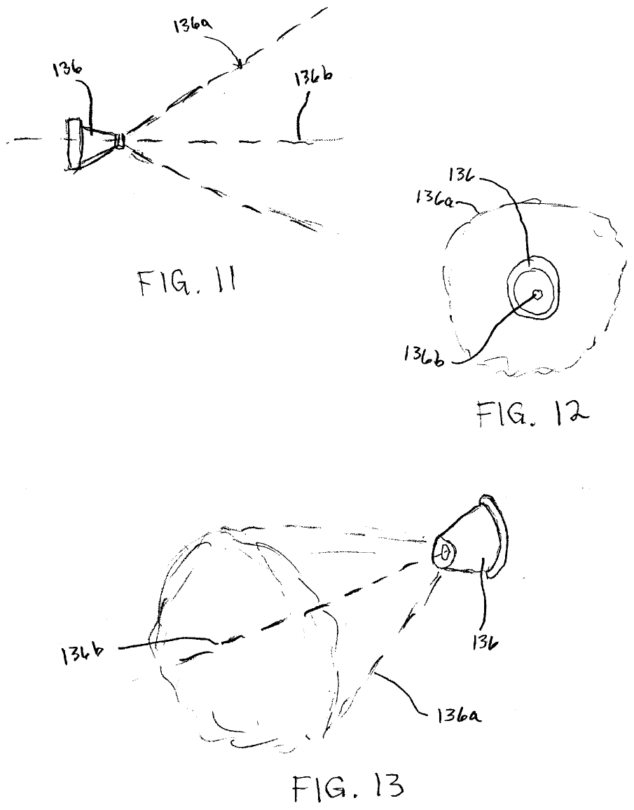

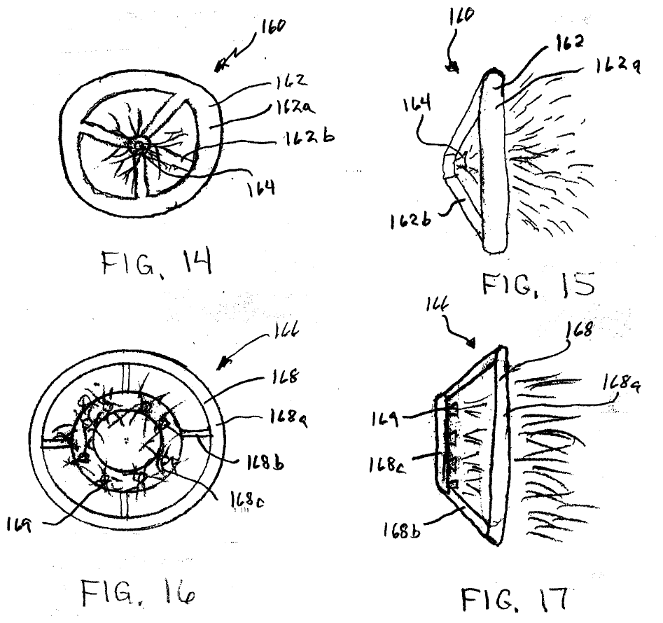

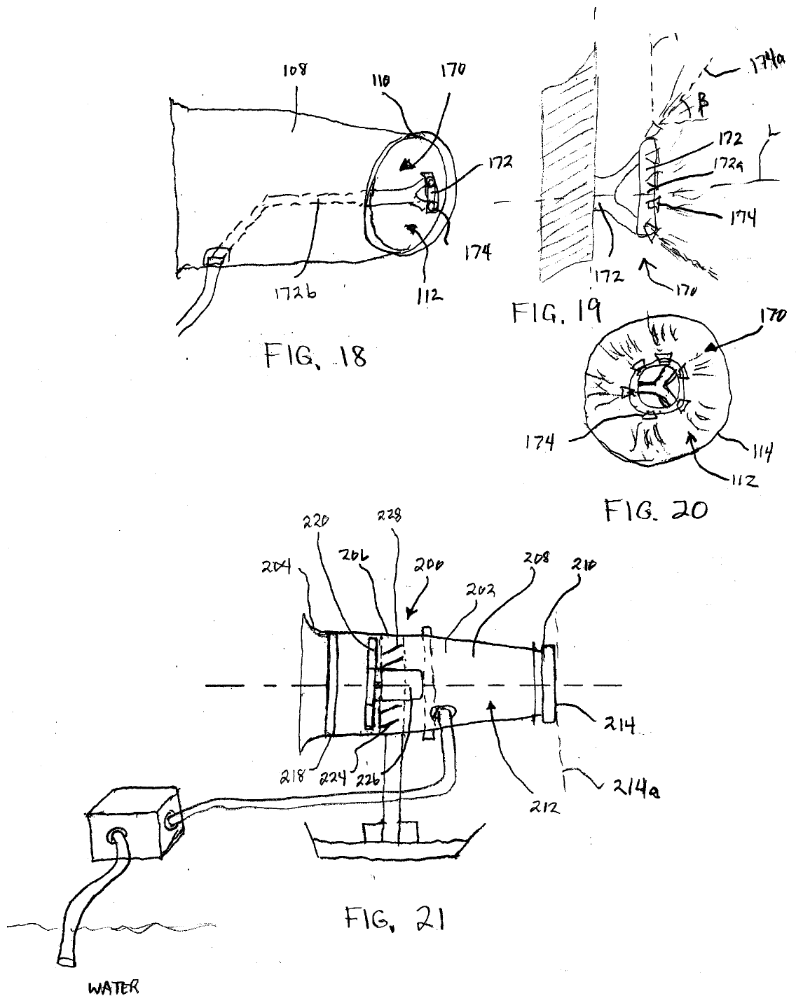

Evaporators according to the various aspects and embodiments of the invention are useful for evaporating water from ambient water bodies, for example, such as ponds, lakes, reservoirs, rivers, tanks, impoundment ponds, flooded areas, and the like, as noted above. To provide an illustrative example, and with reference to FIG. 1, a water body 10 in the form of an impoundment pond is shown in perspective view. The pond 10 is of a type that is commonly found at or near oil and gas drilling sites, mining operations, food processing plants, and the like. It is surrounded at its perimeter by a berm or ledge 12. A plastic or other water-impermeable liner 14 is disposed on the bottom and side surfaces of the pond, over berm or ledge 12 and to an outer perimeter 16. Liner 14 thus retains water 18 within the pond and, by virtue of the liner portion surrounding the pond from the berm or ledge 12 to the outer perimeter, (referred to herein as an “apron 14a”), protects the ground from spills, pond overruns and the like.

A pair of evaporators 20, for example, according to one of the various embodiments disclosed herein, is disposed adjacent to pond 10, in this illustrative example on apron 14a, with one evaporator at each end of the pond. Each evaporator 20 generates a plume 18b of moist air that is directed over the center of the pond.

Evaporators according to presently-preferred embodiments of the invention, in broad terms, direct an air flow stream through an air flow channel and out an air flow exit in a downstream direction. In the process, they inject water from the ambient water body into the air flow stream to facilitate evaporation of that water. Significantly, however, such embodiments and methods comprise injecting the water into the air flow stream at one or more locations that themselves are within the air flow stream. The injection points or locations preferably are proximate to the air flow exit of the evaporator, but even within that proximity they may be located upstream from the exit, downstream from it, at the exit, or at some combination of these. The water injection locations also may include locations along the central or longitudinal axis of the evaporator and of the air flow channel, or at other radial locations, or combinations of these, albeit preferably spaced from the interior wall of the air flow channel The selection of water injection locations indeed may be made and preferably is made in view of or influenced by the velocity profile or profiles of the air flow stream.

An evaporator 100 according to a presently-preferred embodiment of an aspect of the invention will now be described, as will an illustrative method for its use in evaporating water 18 from ambient water body or pond 10 in the setting of FIG. 1. As with each of the presently-preferred embodiments disclosed herein, the air used in the evaporators preferably comprises ambient air present in the local surroundings where the evaporator is located and operates.

In describing this and other embodiments, components and methods herein, it will be convenient to use the relative terms “upstream” and “downstream” to describe the flow of the bulk air within the devices, the relative locations of device components, relative directions or direction of movement and so on. Accordingly, as used herein, the term “downstream” refers to the direction in which the bulk air flows within the evaporator and outwardly from it. In the evaporators disclosed herein, bulk air flow, referred to herein as the “air flow stream,” is from the air inlet end and toward the air flow stream output end or “air flow exit.” Conversely, the term “upstream” means the direction opposite of downstream.

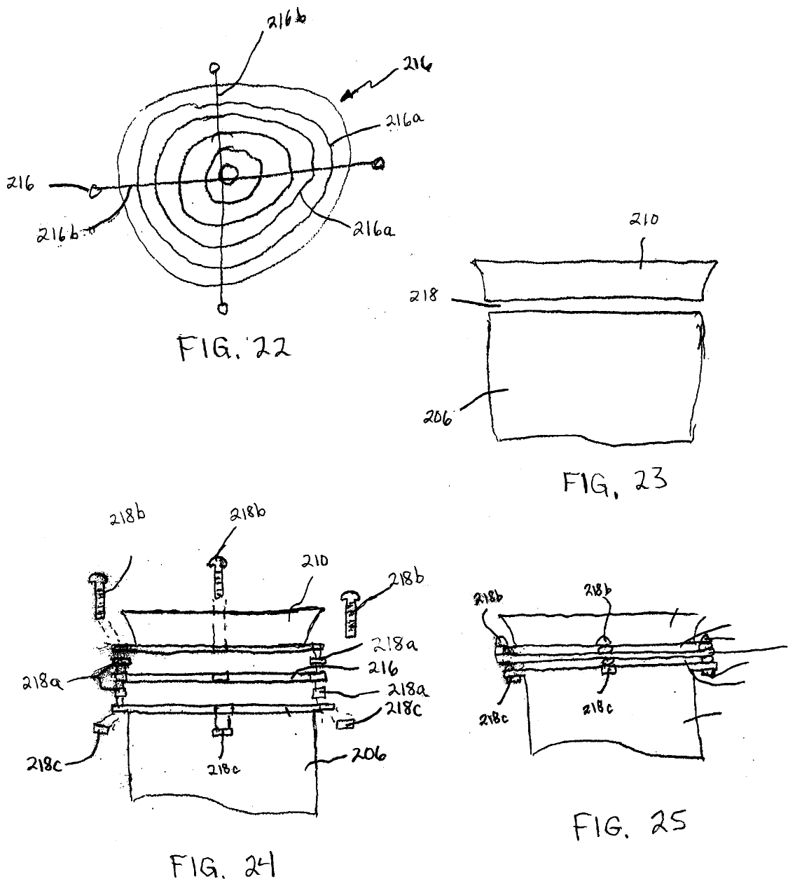

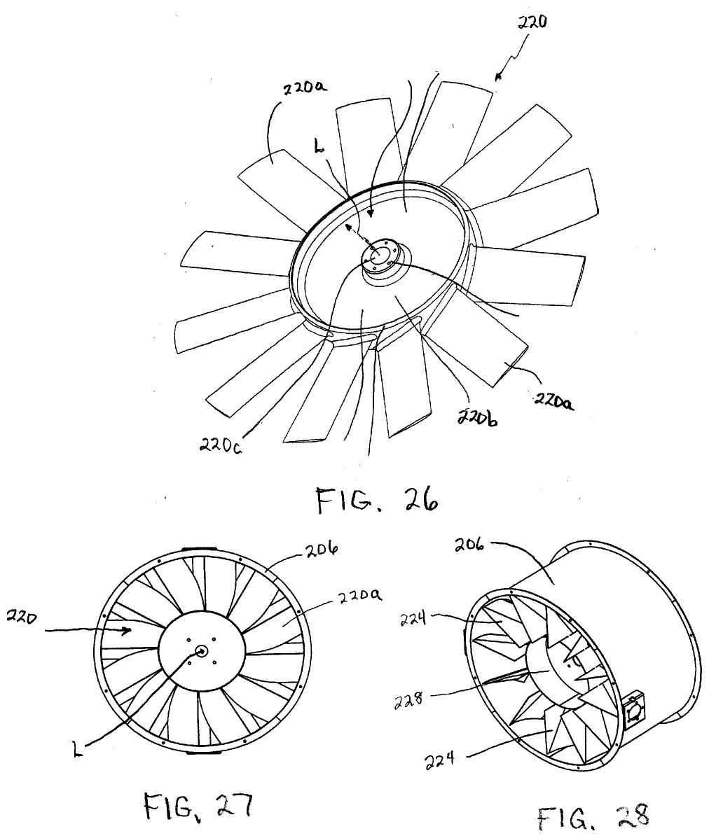

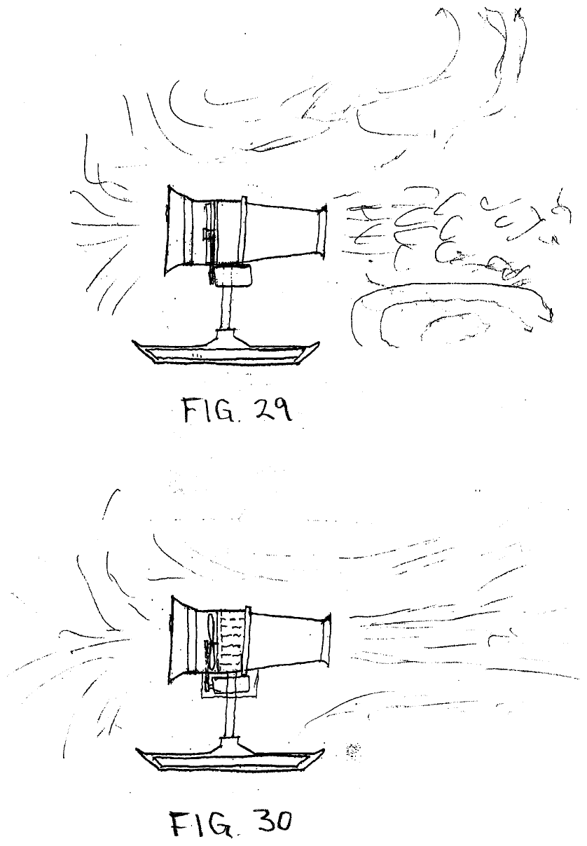

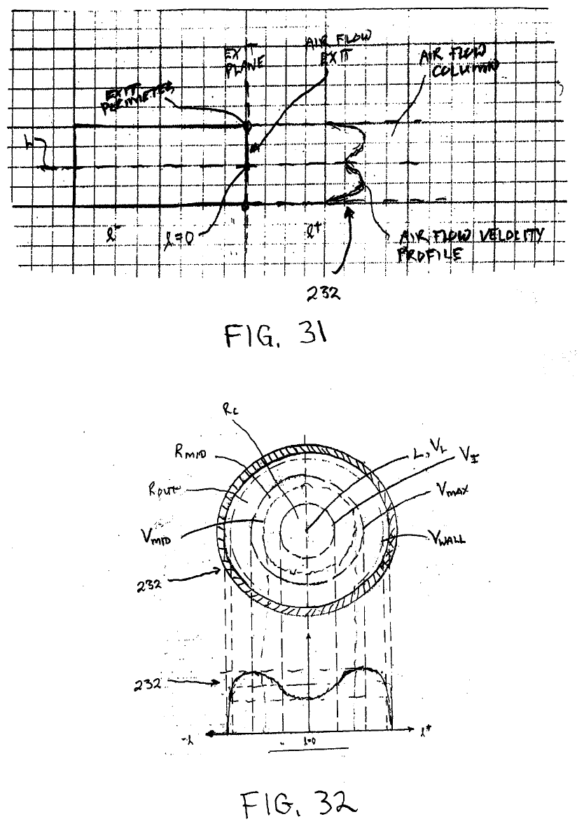

Evaporator 100 is shown in perspective view in FIG. 2. A side cutaway view is provided in FIG. 3. Evaporator 100 includes a housing 102 which in this embodiment comprises—in order from upstream to downstream—an inlet bell 104, a fan casing 106, an outlet cone 108, and an outlet bell 110. These housing components are joined to form a housing air flow channel 112 through which air used in the evaporation process is transported. For reference purposes, air flow channel 112 is disposed about a longitudinal axis L, e.g., as indicated in FIGS. 2 and 3. At the upstream end of this channel 112, air flows into the channel at the upstream or intake side of inlet bell 104, thus forming the air flow stream. The air then continues moving downstream through fan casing 106, through outlet cone 108 and out the outlet bell 110. These components preferably are fabricated from suitable corrosion-resistant materials having appropriate mechanical strength, rigidity and corrosion resistance, for example, such as stainless steel or aluminum. The interior surfaces of the channel 112 components are substantially smooth and largely free of obstructions to air flow, except as expressly described herein.

Inlet bell 104 has suitable curvature to facilitate the flow of ambient air into housing 102 but to mitigate unwanted edge effects that might arise with a sharp cylindrical edge. Outlet bell 110 has similar curvature and effects for the outputted air. Fan casing 106 comprises a substantially-cylindrical section. In this embodiment it has a single-wall construction, and therefore its interior surface 106a is formed by the interior side of the fan casing. This is not, however, necessarily limiting. It may, for example, comprise a double-wall construction, the annular space of which may be insulated, provided with or comprise a heat jacket, and so on. Outlet cone 108 reduces the effective cross-sectional flow area and, based on the conservation of mass and for substantially incompressible fluids under these circumstances such as air, increases the air flow velocity out the outlet bell 110.

The location at which the air exits housing air flow channel 112 is referred to herein as the “air flow exit.” In the presently-preferred embodiments shown and described herein, evaporators employ an outlet bell that, as indicated for outlet bell 110, comprises an outer edge 110a that lies in an exit plane 114a that is perpendicular to longitudinal axis L. In the embodiments disclosed herein, the air flow exit 114 is the portion of that exit plane 114a that is within the interior area of outlet bell 110 lying within the air flow channel 112.

Evaporator 100 also comprises an air flow induction device that facilitates the directing of the air flow stream through the air flow channel and out the air flow exit. In this presently-preferred embodiment, the air flow induction device comprises a propeller-type fan 120 mounted longitudinally in housing air flow channel 112. Fan 120 comprises a plurality of fan blades 120a that extend from a fan hub 120b. Fan blades 120a extend nearly the entire distance from the outer radial edge of the fan hub 120b to the interior wall 106a of fan casing 106, leaving only a small gap between the fan blade tip and wall 106a. A fan axle 120c is disposed on the downstream side of hub 120b, and a fan pulley 120d is disposed on the upstream side of fan hub 120b.

Fan 120 is rotatably mounted to an internal fan mount structure 122 within fan casing 106 so that it rotates within fan housing 106. More specifically, fan mount structure 122 includes a receiver or bearing assembly 122a with an aperture 122b disposed longitudinally, and fan axle 120a is rotatably disposed in bearing assembly 122a.

Bearing assembly 122a is held in fixed position in the longitudinal center of fan casing 106 by a plurality of guide vanes 124 distributed radially within fan casing interior surface 106a with uniform spacing around the fan casing interior 106a. Each of the guide vanes 124 has an upstream leading edge 124a and is disposed so that the leading edges 124a of all of the guide vanes lie along a leading edge plane 124b that is orthogonal with respect to the longitudinal axis L. The fan blades 120a are positioned so that the leading edge plane 124b is located as close as is practicable to the downstream edge of fan blades 120a. Each guide vane 124 is substantially planer and is disposed so that the longitudinal axis L lies in each of the respective guide vane planes, so that the leading edge 124a of each guide vane is directly in line with and is conformal with the trailing edge 124c of that guide vane. Guide vanes 124 advantageously function to straighten out non-longitudinal flow in fan casing 106 caused primarily if not exclusively by the rotational movement of fan 120, so that the air flow stream is more longitudinal.

A motor 126 is disposed outside of the housing 102 directly below fan casing 106. Motor 126 is positioned so that its shaft 126a is parallel to and directly below longitudinal axis L. A motor pulley 126b is attached to shaft 126a and is positioned directly below fan pulley 120d. Fan pulley 120d and motor pulley 126b are coupled via a drive belt 126c so that rotation of motor shaft 126a is translated to rotation of fan 120. Motor 126 is coupled to an appropriate power source and control circuitry.

When power is applied to motor 126, it causes fan 120 to rotate, both of which fairly quickly reach their normal or design operating rotational rates, e.g. , in this embodiment of about 1,200 revolutions per minute (“RPM”). This rotation of fan 120 causes the flow of air through the housing air flow channel 112, drawing ambient air into air flow channel 112 at inlet bell 104, through fan casing 106 and outlet cone 108 and out the outlet bell 110. As the operation of the evaporator reaches steady state at a given air flow rate, a steady air flow stream will be established in flow channel 112. As the air flow stream emerges from the air flow channel at air flow exit 114, it will typically have a general air flow velocity profile 132-0 as is graphically depicted in FIG. 4, which shows this profile from a side perspective relative to flow channel 112, and in FIG. 5, which shows an end or longitudinal view of the profile.

Given the construction of fan 120, which has a relatively small hub 120b and long, thin blades 120a that extend for most of the radial distance from longitudinal axis L to interior wall 106a of the fan casing 106, the air within air flow channel 120 along most of its radius experiences essentially the same flow induction impulse. This promotes a uniform velocity profile across essentially the entire radius of the channel 112. Portions of the air adjacent to interior fan casing wall 106a will experience some level of drag associated with viscous forces and therefore there will be a reduction in velocity at radial positions approaching interior fan casing wall 106a. Assuming viscous flow, theoretically the velocity will be zero at the wall r_{wall}, and, given the low viscosity of air, will quickly increase at radial positions moving away from wall 106a. With reference to FIG. 5, for example, the air flow velocity at radial position r₁ will be relatively small, but it will be significantly greater at position r₂. At or near the radial center or longitudinal position L, the air flow velocity will reach its maximum velocity rₘₐₓ. These features yield a generally-parabolic air flow velocity profile, e.g., as shown in FIGS. 4 and 5.

In practice, the presence of fan 120, and more particularly fan hub 120b, will have some effect on the air flow velocity profile and will modify it to some extent. Hub 120b will provide a barrier or obstruction to air flow, and the air flow stream will adapt to move around it. This disturbance will cause turbulent eddies at and around the longitudinal center of the air flow stream and thus will slow the velocity of the air flow stream at this center. Given the relatively small size of fan hub 120b and the relative uniformity of the fan blade shape profiles, however, this center effect can be reduced or minimized so that the parabolic velocity profile 130 can be approached or approximated.

Evaporator 100 also comprises a water provisioning system that includes one or more water injection devices to inject the water from the water body into the air flow stream at one or more water injection locations within the air flow stream, preferably proximate to the air flow exit. Water provisioning systems according to presently-preferred embodiments of this aspect of the invention not only inject water from the ambient water body into the air flow stream, but they inject that water at a location or locations that themselves are within the air flow stream, as noted herein above. To illustrate, and with reference to FIGS. 6 and 7, for example, known evaporators typically use a round spray ring positioned at or proximate to the downstream end of the evaporator. The spray ring surrounds the downstream end of the evaporator so that the air stream emerging from such evaporator passes through the interior of the spray ring. Nozzles disposed on the spray ring spray water with the intention of mixing the water into the air flow stream. In so doing, it is hoped and intended that the water droplets will infiltrate into the air stream and be carried with it to thereby facilitate evaporation.

Evaporators of this known type have demonstrated consistent and in some cases extreme inefficiencies, for example, in that the water often fails to effectively penetrate into the air stream to the extent desired or intended. Although not wishing to be limited to any particular theory of operation or underlying mechanism or phenomenology, it is believed that the water and water droplets from the spray ring nozzles impact the relatively high-speed stream of air near at the outside of the air stream, e.g., as indicated by arrows A in FIGS. 6 and 7, and in many cases this results in elastic collisions of the air and water that have the net effect of repelling the water and water droplets from the air stream. To the extent that water droplets are able to penetrate into the air stream in such evaporators, portions of these droplets may be effectively propelled back out of that stream based on the same phenomenon and based on the turbulent and rotational flow within the air stream that tends to rotate the relatively higher-velocity flow at and around the longitudinal axis L radially outward over the relatively slower air near the radial periphery of the air stream. The water droplets themselves also collide with one another, often inelastically, in which case the droplets become larger and larger and eventually precipitate out and fall to the ground or water surface 18a.

Evaporators according to presently-preferred embodiments of this aspect of the invention mitigate or overcome such limitations and improve mixing and evaporation efficiency relative to known systems at least in part by injecting the water into the air flow stream at a location or locations within the air flow stream itself, rather than from outside of the air flow stream.

The water provisioning system of presently-preferred embodiments of this aspect of the invention comprises a water feed system and a water injection system. As has been noted herein, the evaporator evaporates water from the ambient water body principally by injecting the water into the air flow stream emanating from the air flow channel. The water feed system provides water from the ambient water body to the evaporator or a selected part of it. The water injection system receives this water from the water feed system and injects it into the air flow stream at the appropriate water injection location or locations.

The water may be transported to the evaporator and ultimately to the water injection device or devices in a number of ways. The water feeding configuration in evaporator 100 will now be described to provide an illustrative and preferred example. Evaporator 100 typically will be operated at or near to the ambient water body, for example, on apron 14a as shown in FIG. 1. As shown in FIGS. 2 and 3, a water feed conduit 142, which preferably comprises a flexible but durable suction hose, includes a first end 142a that is disposed in the body of water from which to collect water 18, and a second end142b coupled to a pump assembly 144. Pump assembly 144 comprises a pump 144a fluidically coupled to second end 142b of hose 142. Pump assembly 144 also comprises a motor 144b that is used to drive pump 144a. The output side of pump 144a is fluidically coupled to a water feed conduit 146 at a first end 146a. Water feed conduit 146 is fluidically coupled at a second end 146b to a housing coupler 148 disposed at the bottom or side of housing 102 of evaporator 100.

According to presently-preferred embodiments and methods, water from the water body is injected into the air flow stream at one or more water injection locations within the air flow stream. A water injection location is a specific spatial location within the air flow stream at which water is injected. The injection of water in presently-preferred embodiments and method implementations is manifested by a water injection device that injects the water at the water injection location. A water injection device may comprise, for example, an aperture in a pipe, hose or other body, a nozzle, an atomizer, and the like. A water injection device may occupy a particular water injection location as the sole water-injecting source. Alternatively, there may be a plurality of water injecting devices positioned at a particular water injection location or common location. The term “water injection node” is used herein to refer to either or both of these situations or configurations.

A means is provided for fluidically coupling the water feed system to the water injection device or devices—the water injection nodes—so that the former can provide water to the latter. In some instances, a simple and direct connection can be made, e.g., by providing a pipe or similar conduit directly from the water source to the node. In others, however, it is desirable or advantageous to attach one or more water injection nodes to a supporting or intermediate pipe, ring, cavity or the like that can feed or support multiple nodes. Such device is referred to herein as a “manifold.”

As implemented in evaporator 100, e.g., as shown in FIGS. 2 and 3, an internal conduit or conduit network 152 is coupled at its first end 152a to housing coupler 148 to fluidically couple the water feed system 140 to the water injection system at this location. Although conduit or conduit network 152 in turn may be is coupled at its second end 152b directly to one or more water injection devices or nodes, it also may be coupled to one or more manifolds.

In evaporator 100, second end 152b of conduit 152 is coupled to a water injection manifold, an example of which is provided in water injection configuration 154, shown in FIGS. 8 and 9. With reference to those drawing figures, water injection configuration 154 comprises a water injection manifold 156 is disposed at air flow exit 114. Manifold 156 itself is shown in longitudinal view in FIG. 8 and a side view is provided in FIG. 9. Manifold 156 is fluidically coupled via the end 152b of conduit 152 to receive water from the water feed system. Manifold 156 includes a hollow circular tubular ring 156a that is fixedly attached to outlet bell 110 in the exit plane. Manifold 156 further comprises three hollow tubular spokes 156b fluidically coupled to tubular ring 156a and also lying in exit plane 114a. A hub 156c is disposed at the longitudinal center of manifold 156 and is coupled physically and fluidically at the joinder of spokes 156b. A water distribution device in the form of a single nozzle 158 is disposed at the longitudinal center of hub 156c and in exit plane 114a.

The water injection location or locations, although as a general matter preferably being proximate to the air flow exit, may vary in their longitudinal position relative to the air flow exit plane and radially relative to longitudinal axis L.

To illustrate, and with reference to FIG. 4, for example, one may demarcate or measure positions relative to the longitudinal axis L using the length or distance variable [symbol] . The longitudinal position of air flow exit plane 114a is taken as the origin and thus [symbol] =0. The distance marker [symbol] is positive for longitudinal positions that are downstream with respect to the exit plane (i.e., positions that are to the right of exit plane 114a in FIG. 4), and marker [symbol] is negative for longitudinal positions that are upstream with respect to the exit plane (i.e., positions that are to the left of exit plane 114a in FIG. 4). Using these conventions, the water injection location or locations may comprise a location or locations that are upstream of the air flow exit ( [symbol] <0) and thus in the housing air flow channel, a location or locations that are disposed at the air flow exit ( [symbol] =0), a location or locations that are downstream of the air flow channel and thus downstream of the air flow exit ( [symbol] >0), or combinations of these.

The water injection location or locations also may vary radially with respect to the longitudinal axis L, provided they are within the air flow stream. Using the variable r to indicate the radial position of the water injection location or node with respect to the longitudinal axis, r=0 at the longitudinal axis L, and r=R where R represents the outer radius for a given longitudinal position that is still within the air flow stream. For nodes that are at air flow exit 114, r=R is a radial position spaced from the interior surface or perimeter of outlet bell 104 at exit plane 114a and within the air flow stream. For longitudinal positions that are upstream of the exit plane and thus within the air flow channel 112, R represents a radial position spaced from the interior surface of the air flow channel, e.g., of fan casing 106 and outlet cone 108 and within the air flow channel

For longitudinal positions downstream of the exit plane 114a, defining the radius R is somewhat more complicated but is still achievable. As the air flow stream emerges from the air flow channel past the exit plane and continues downstream, it will expand and diverge. With reference to FIG. 10, which shows a side view of an evaporator with associated air flow stream and plume, at the exit plane of the evaporator, ( [symbol] =0), the cross-sectional shape of the air flow stream is well defined, as shown by longitudinal cross-section 132-0. As the air flow stream moves downstream, e.g., to a longitudinal position where [symbol] = [symbol] ₁, it has expanded to larger cross section 132-1, and its boundary has become somewhat less distinct. At cross section 132-1, the density of the air within the cross section will be generally lower than that of cross section 132-0 in proportion to this expansion. As the air flow stream continues to move downstream, e.g., to a longitudinal position where [symbol] = [symbol] ₂, it has expanded to an even larger cross section 132-2 with a boundary that is still less distinct. At cross section 132-2, the density has continued to drop. Based on what may comprise asymmetric forces, external air flows from external ambient air, etc., the outer edges of the air flow stream at this point may become more irregular or poorly defined.

In presently-preferred embodiments, it is preferred that water injection locations extend a reasonable distance longitudinally downstream of the air flow exit, but not more than a reasonable distance under the circumstances. For the illustrative evaporators shown and described here, for example, for which the fan casing has a diameter of about 42 inches, the air flow channel is about 4 to 6 feet in length, and the air flow rate is about 18 to 20 cubic feet per minute (“CFM”), a reasonable distance for water injection locations preferably would extend about 2 to 4 feet downstream from the exit plane. Although this is not necessarily limiting, within this range the air flow is still fairly well developed and a distinction can be

One also may assess the boundaries of the air flow stream by determining empirically or semi-empirically the radius at a fixed longitudinal point at which the air flow velocity drops off to a

As noted herein above, the outlet of the air flow channel may not always lie in a plane orthogonal with respect to the longitudinal axis. The radial position of the water injection location or locations may be expressed in rectangular or cylindrical coordinates. Where there is a characteristic cross-sectional dimension and some element of symmetry, for example, such as a cylindrical or conical air flow channel geometry, and some degree of symmetry about that characteristic dimension, such as in air flow channel 112 of evaporator 100, the position of a water injection location or locations, or a region within which such locations lie, such as the spaced radial region described above, may be expressed as a percentage of the this characteristic dimension, e.g., the radius, of the air flow exit. The term “radius” as used here refers to this characteristic dimension, as would be appropriate for the presently-preferred embodiments disclosed herein. But this is not intended to necessarily imply that the air flow housing may only have a cylindrical, conical or other symmetric shape.

Although a water injection location as the term is used herein refers to a point location within the air flow stream, one or more water locations also may be designated as lying with a region or volume. One may position the water injection location or locations, for example, within a cylindrical volume defined by the area within a radius r around the longitudinal axis L at which the water injection location or locations are positioned, and by a length (Δ [symbol] ) along the longitudinal axis L of the cylindrical volume.

Similarly, for annular regions disposed about the longitudinal axis in which the water injection location or locations are disposed, one may define or designate such annular region by the radial extent of the annular region (r₂−r₁), where r₁ is the inner or smaller radius and r₂ is the outer or larger radius, and the length (Δ [symbol] ) along the longitudinal axis L of the annular volume. Using this percentage of characteristic dimension approach, where air flow exit has an interior radius R normal to the longitudinal axis, in presently-preferred embodiments the radially spaced location or locations are spaced between the longitudinal axis and about 75% of the radius R relative to the longitudinal axis.

One also may select or vary the direction of the water injection at a given water injection location. Some water injecting devices inject the water as a linear or substantially stream or jet of water. The direction of such devices clearly can be characterized by this jet or line of injection. Many other water injection devices do not inject water as what is tantamount to a straight line. With some such devices, however, one often can select or define a characteristic direction that provides a representation of the direction in which that device injects water into the air flow stream.

In the case of many nozzles for example, and with reference to FIG. 11-13, nozzle 136, which comprises a generally conical shape, produces a substantially-conical spray pattern 136a. The conical spray pattern is disposed about a longitudinal axis that lies at the center or axis of the cone and, although the spray pattern or water injection is conical, its direction can be characterized or defined as the line or vector coincident with the longitudinal axis of the nozzle. This characteristic or defining direction is referred to herein as the “principal direction” 136b of the water injection for this nozzle 136. Nozzle 136 as shown in FIG. 11 projects water outwardly radially in a substantially-conical flow pattern having an angle θ with respect to principal axis136b. In the drawing figures, the angle θ is about 45 degrees for this nozzle.

Of course, there are instances in which a water injecting device does not possess what can reasonably be defined as having a single characteristic or defining direction. An example would be a nozzle that provides a substantially planar 360-degree spray pattern. Although the injection pattern of such a nozzle would comprise all the theoretically infinite number of directions lying in the plane of the spray pattern, it would not have a single characteristic direction. The same reasoning would apply to a spray or injection pattern that extended over three spatial dimensions.

Using this convention regarding water injection direction, presently-preferred evaporator embodiments may comprise a water injection device that is configured to inject the water into the air flow stream in the downstream direction, i.e. , where the device injects water in a principal direction or which comprises a direction that is in the downstream direction or parallel to the longitudinal axis. Such embodiments also may comprise a water injection device that is configured to inject the water into the air flow stream in the radial direction, i.e., where the device injects water in a principal direction or which comprises a direction that is orthogonal with respect to longitudinal axis. Such embodiments also may comprise a water injection device that is configured to inject the water into the air flow stream in directions that are between the downstream or longitudinal direction and the radial direction. There are distinct advantages in a range of embodiments and applications in which it is preferable to have water injection directions in the radial direction or that are substantially radial. These advantages include without limitation potentially better infiltration of the water into the full cross section of the air flow stream. This water injection may be used in conjunction with considerations of the water injection pressure and water flow velocity relative to the cross sectional size and flow velocity of the air flow stream so that the water interacts with and is absorbed by substantially the full cross section of the air flow stream but the water is not driven beyond the radial boundary or extent of the air flow stream.

As indicated above, a water injection location may lie at any location longitudinally, i.e., at the exit plane, upstream from it or downstream from it, and at any location radially with respect to longitudinal axis L, provided it is within the air flow stream, and preferably spaced radially with respect to the air flow exit.

In view of the foregoing, it may be noted that, as shown in FIG. 3, nozzle 158 of water injection configuration 154 (FIGS. 8 and 9) is disposed at a water injection location that is on the longitudinal axis and thus centered radially in the air flow channel, i.e., r=0, and it is disposed at the air flow exit plane with regard to longitudinal position, i.e., [symbol] =0.

Water injection configuration 160, shown in FIGS. 14 and 15, provides another example of a manifold similar to manifold 156. As with manifold 156, manifold 162 is disposed at or proximate to air flow exit 114. It is fluidically coupled via the end 152b of conduit 152 to receive water from the feedwater system. Also as with manifold 156, manifold 162 comprises a hollow circular tubular ring 162a attached to outlet bell 110 at the exit plane. Manifold 162 similarly has three tubular spokes 162b fluidically coupled to ring 162a. In contrast with spokes 156b of manifold 156, however, spokes 162b extend at an angle into the air flow channel 112 upstream with respect to the exit plane 114a. A hub 162c is disposed at the longitudinal center of manifold 162 and is coupled physically and fluidically at the joinder of spokes 162b. Given the configuration of spokes 162b, hub 162c also is within the air flow channel 112 upstream of exit plane 114a. A water distribution device in the form of a single nozzle 164 is disposed at the longitudinal center of hub 162c. Thus, this manifold 162 injects water at a water injection location that is within the air flow channel upstream of the exit plane. This positioning allows the tubular manifold ring 162a to be positioned outside of the air flow channel and out of the air flow stream and reduces or minimizes air flow disrupting effects of the spokes 162b but injects water directly into the center of the air flow stream.

It may be noted that one may vary the angle of the spokes 162b with respect to the manifold ring 162a to modify or adjust not only the water injection location but the extent of the physical disruption of the air flow caused by the spokes.

Another illustrative water injection configuration 166 similar to configuration 160 is shown in FIGS. 16 and 17. As with configuration 160, configuration 166 comprises a manifold 168 that includes a tubular ring 168a attached to outlet bell 110 at exit plane 114a and disposed at or proximate to air flow exit 114. Manifold 168 is fluidically coupled via the end 152b of conduit 152 to receive water from the water feed system. Manifold 168 has four tubular spokes 168b fluidically coupled to ring 168a. As in manifold 162, spokes 168b extend at an angle into the air flow channel upstream with respect to exit plane 114a. A ring hub 168c is disposed about the longitudinal center of manifold ring 162a and is coupled physically and fluidically to spokes 168b. Spokes 168b position hub 168c within the air flow chamber upstream of the exit plane. A plurality of water distribution devices in the form of a plurality of nozzles 169 is disposed at spaced locations around the downstream side of hub 168c. This manifold 168 injects water at a plurality of water injection locations that are within the air flow channel 112 upstream of exit plane 114a. It has the same flow disruption avoidance features of manifold 162 but is capable of providing substantially more water to the air at a greater rate.

Still another illustrative water injection configuration 170 is shown in FIGS. 18-20. Configuration 170 comprises a manifold 172 that includes a tubular ring 172a attached to an elongated tubular support 172b that positions and supports ring 172a at a longitudinal position just downstream of the exit plane 114a. A plurality of water injection devices comprising atomizing nozzles 174 are disposed on the outer edge of ring 172a spaced equally around ring 172a. Manifold 170 is fluidically coupled via the end 152b of conduit 152 to receive water from the water feed system. This manifold 168 injects water at a plurality of water injection locations that are downstream of the air flow channel 112 and exit plane 114a. Nozzles 174 project water at an angle β of their principal direction 174a relative to air flow channel longitudinal axis L. The angle β reflected in FIG. 17 is about 45 degrees, but this angle β may be varied, for example, from directly downstream or longitudinal, i.e., β=0, to directly radial, i.e., β=90, e.g., outwardly radially with respective principal directions that lie along a plane that is perpendicular to the longitudinal axis L of the air flow channel 112, and at values between these.

Note that, instead of nozzles 174 having angles that planes in which the longitudinal axis lies as in this configuration, or in addition, nozzles 174 also could be configured to inject the water into the air flow stream tangentially with respect to tubular ring 172a, and thus which do not intersect longitudinal axis L.

An evaporator 200 according to another presently-preferred embodiment of an aspect of the invention will now be described. Evaporator 200, a side cutaway view of which is shown in FIG. 21, is similar if not identical to evaporator 100 as described herein above, but with several exceptions as noted herein below. Externally, evaporator 200 looks essentially the same as evaporator 100, for example, as shown in perspective view in FIG. 2. It differs in internal componentry and construction, for example, in that it comprises a modified and improved air flow induction device comprising an improved impeller.

Evaporator 200 includes a housing 202 which in this embodiment comprises, in order from upstream to downstream, an inlet bell 204, a fan casing 206, an outlet cone 208, and an outlet bell 210. These components comprise a housing air flow channel 212 disposed about a longitudinal axis L through which ambient air is transported from upstream to downstream to facilitate the water evaporation. Housing 202 comprises an air flow exit 214 and an air flow exit plane or exit plane 214a as described herein above for evaporator 100.

A circular air inlet grille 216 is disposed between the downstream end of inlet bell 204 and the upstream end of fan casing 206. Inlet grille 216 is shown in position on evaporator 200 in FIGS. 21 and 23-25 and separately in FIG. 22. It includes a plurality of concentric circular grille rods 216a spaced apart from one another, and a plurality of radial support rods 216b. A ring 216c is disposed at the end of each support rod 216b to receive a machine screw or other fastener. Preferably but optionally the grille rods 216a are spaced about one-half inch apart from one another.

According to another aspect of the invention, an air gap is provided in the distal or upstream end of the housing downstream of the inlet bell or other corresponding air inlet and spaced from the upstream edge of the housing flow channel. This air gap allows the entry of air through the gap and into the housing flow channel to mitigate undesirable edge effects that arise when sharp edged intake conduits are used.

In presently-preferred evaporator embodiments, and with reference to the illustrative housing section in FIGS. 23-25, an air gap 218 is provided between the downstream edge of air inlet bell 204 and the upstream edge of fan casing 206. Air gap 218 optionally but preferably extends all the way or substantially all the way around the perimeter of the housing 202, preferably orthogonally with respect to longitudinal axis L. In terms of its function, although not wishing to be limited to any particular theory of operation, the inventors believe that as air flows into the inlet bell and into the cylindrical fan casing section of the housing, in the absence of the air gap, edge effects and other flow interruptions cause the air being inducted into housing flow channel 212 to experience boundary layer separation and turbulent eddy flow that reduce the flow rate down the flow channel. By introducing an air gap proximate to the upstream end of the housing air flow channel, low pressure zones that can give rise to these effects are mitigated by the flow of air into these low-pressure zones through the air gap.

As specifically implemented in evaporator 200, air gap 218 is sandwiched between inlet bell 204 and fan casing 206. More specifically, a flange 204a is disposed at the downstream edge of inlet bell 204, and a corresponding flange 206c is disposed at the upstream edge of fan casing 206. Mating holes are provided in each of these flanges corresponding to rings 216c in grille 216. Spacers 218a, preferably comprising an elastomeric or polymeric material, are provided at the loops and holes immediately above and immediately below grille 348. Machine bolts 218b and mating nuts 218c are used to position and fix or immobilize inlet bell 204, grille 216 and fan casing 206 relative to one another, and spacers 218a space these components to create and maintain air gap 218. The air gap 218 of course will depend on the specific configuration of the evaporator, for example, including its sizing and flow dynamics, but as an example, air gap 218 in evaporator 200 is a uniform one-half inch spacing.

Evaporator 200 also comprises an air flow induction device which in this embodiment comprises an impeller 220 mounted longitudinally in housing air flow channel 212. Impeller 220, shown configured in evaporator 200 in FIGS. 21 and 27 and shown separately in FIG. 26, comprises a plurality of impeller blades 220a that extend from an impeller hub 220b. Impeller 220 is sized so that its blades 220a extend nearly the entire distance from the outer radial edge of the fan hub 220b to the interior wall 206a of fan casing 206 and leave only a small gap between fan blade tip and wall 206a. Impeller 220 comprises or consists essentially of an integrally-molded fiberglass structure in which the hub 220b and impeller blades 220a are molded as a continuous and substantially homogenous material. Further details and preferred embodiments of impeller 220 and related embodiments, systems and methods, are disclosed and shown in commonly-owned and assigned U.S. Provisional Application No. 62/656,856, incorporated herein by reference as indicated herein above.

As shown, for example, in FIGS. 21 and 28, impeller 220 is rotatably mounted to an internal support structure that comprises a C-frame mount 228 within fan casing 206. C-frame mount 228 is fixedly supported in fan casing 206 by a plurality of guide vanes 224 uniformly spaced around the interior 206a of fan casing 206. Each guide vane 224 comprises an upstream or leading edge and is disposed so that the leading edges of all of the guide vanes lie along a leading edge plane orthogonal with respect to longitudinal axis L. The upstream side of leading edge plane is positioned as close as is practicable to the downstream edges of fan blades. Rather than being straight longitudinally as in evaporator 100, the surfaces of guide vanes 224 of evaporator 200 are curved in the downstream direction so that torsional components of air flow off the impeller are reduced and the air flow is made more linear and developed.

In evaporator 200, a motor 226 similar to motor 126 is disposed longitudinally within fan casing 206, coupled to the downstream side of C-face mount 228. Motor 226 is disposed so that its shaft 226a directly couples to axle 220c of impeller 220. Motor 226 is coupled to an appropriate power source and control circuitry, for example, as described more fully herein below.

Although evaporator 100 provides a number of advantages over known designs, evaporator 200 provides additional advantages. A significant example involves the improvements in developed air flow within and around the evaporator.

In many evaporators of the general type described herein, the air flow within the air flow channel and immediately downstream of it is poorly-developed, with substantial turbulence and eddies, for example, as illustrated in FIG. 29. This turbulent flow causes flow resistance, it impedes air flow out of the evaporator and away from it, and it impedes downstream flow development and air flow within the downstream plume. It also creates an environment in which the water droplets, newly-formed by water sprayed into the air stream, are more likely to collide within the air stream or plume and thereby coalesce to form larger droplets. These larger, heavier water droplets afford less surface area for effective evaporation. They also have a greater tendency to fall out of the plume or air flow via gravitational force and settle back into the water body, to the ground, and so on. Ambient air around the evaporator and the plume, which is drawn downstream by the momentum of the plume, can exacerbate this effect, for example, by pulling the heavier water droplets into this more circular flow and increasing the settlement rate.

The incorporation of impeller 220 or of an impeller as described in U.S. Provisional Application No. 62/656,856, particular in conjunction with appropriate guide vanes, can significantly improve the quality and efficiency of the air flow out of the air flow channel and in downstream plume, for example, as illustrated in FIG. 30. As more fully explained in U.S. Provisional Application No. 62/656,856, the impeller, especially in combination with other features as described herein and in the aforementioned provisional application, such as guide vanes, provide an improved, well-developed air flow with lower turbulence and fewer and shorter turbulent eddies. This can allow the atomized or small water droplets to sustain their inherently greater surface area available for evaporation with a reduced probability of collision and unwanted coalescence and settling. It can permit better water and air mixing. It also can project a more well-formed plume. It can more effectively draw in and project the air flow surrounding the evaporator and plume, and it can provide an improved opportunity for the water droplets to undergo wet bulb temperature depression and reach their wet bulb temperature.

FIGS. 31 and 32 show an illustrative air flow velocity profile 232 for evaporator 200 operating at steady state during normal operation, similar to the profile of FIGS. 4 and 5. Rather than the substantially parabolic velocity profile 132 in FIGS. 4 and 5, profile 232 of FIGS. 31 and 32 is generally toroidal in shape, with a relatively low but sharply increasing velocity near the interior walls of fan casing 206a, moderate to relatively low velocity at and about the radial center or longitudinal axis L, and relatively high velocities in between, with maximum velocity V_{MAX} at a radial position generally midway from axis L to interior fan casing wall. This profile 232 is attributable in large part to the air flow obstacle posed by the relatively larger hub 220b of impeller 220 and associated motor arrangement. It may be noted, incidentally, that the air flow within air flow channel 202, although often significantly straighter and more developed than that for known evaporators and even relative to evaporator 100, is not normally laminar, at least not to a significant extent.

Evaporator 200 also comprises a water provisioning system for injecting water into one or more water injection locations within the air flow stream. The water provisioning system of evaporator 200 comprises a water feed system as described above for water feed system 140 of evaporator 100. This water provisioning system also comprises a water injection system which, for example, may comprise the various water injection configurations described above with respect to evaporator 100. Given the differences in air flow velocity profiles between the two evaporator designs, however, as reflected, for example, in FIGS. 4 and 5 versus FIGS. 29 and 30, evaporator 200 alternatively may comprise any of the arrangements described herein below.

One may segregate the air flow velocity profile 232 for evaporator 200 into multiple regions. As an example, and with reference to FIG. 30, three reference lines or curves of demarcation may be used, in addition to the radial center of the profile V_{L} which lies at the longitudinal axis L. One such line is the interior wall 206a of fan casing 206. A second line is the location between axis L and fan casing wall 206a where the air flow velocity is at a maximum, designated herein as V_{MAX}. A third line can be selected that lies at an intermediate or inflection point V₁ between V_{MAX} and the velocity at the radial center V_{L}.

With regard to line corresponding to interior fan casing wall 206b, because the air flow velocity at and immediately adjacent to fan casing wall 206b is low, (theoretically zero at the wall for viscous flow), and rises rapidly as one moves away from the wall radially, preferably a line V_{WALL} spaced from fan casing wall 206b may be selected or used instead of fan casing wall 206b itself. The line V_{WALL} preferably is selected so that it omits the portion of the air flow that is unduly affected by wall effects, e.g., viscous effects at the wall, rapid flow velocity changes, and the like. One also may select V_{WALL} to correspond to a location in the profile at which the air flow velocity is approximately equal to that of other portions of the profile, e.g., the velocity V_{L} at the radial center or axis L, or a midpoint between this radial center velocity V_{L} and V_{MAX}. Similarly, one may select V_{WALL} to correspond to a location spaced from fan casing wall 206b at which the air flow velocity according to the profile is a predetermined percentage of a reference air flow velocity, e.g., such as V_{MAX}. Using this approach, for example, one may select V_{WALL} to be the location on the profile adjacent to wall 206b at which the air flow velocity according to the profile is, for example, 90 percent of V_{MAX}.

Once reference lines are selected, they can be used to select the one or more water injection locations.

In a number of presently-preferred embodiments and related methods, for example, one or more water injection devices or nodes is disposed at longitudinal axis L. Examples of water injection configurations that provide this feature include configuration 154 as shown in FIGS. 8 and 9 and configuration 160 as shown in FIGS. 16 and 17. These configurations can take advantage of the fact that the water injection point or points are at a maximum radial distance from the outer edge of the air flow velocity profile and has the entire radial length of the profile for which the water to diffuse into the air flow stream.

One also may dispose water injection locations at or along one or more of the reference lines, for example, such as disposing water injection nozzles at spaced locations along or proximate to line V_{MAX}, or along or proximate to lines V_{MAX} and V₁. Examples include configuration 166 as shown in FIGS. 16 and 17 and configuration 170 as shown in FIGS. 18-20. In these and still other embodiments and methods, water injection locations are disposed at a midpoint between the longitudinal axis L and a wall of the air flow channel, e.g. , such as at V_{MID} in FIG. 20. Again, examples include configuration 154 as shown in FIGS. 8 and 9 and configuration 170 as shown in FIGS. 18-20.

One also may use these lines to demarcate regions within the air flow velocity profile in which water injection locations are to be disposed. Using the center velocity V_{L} and the three reference lines identified herein above, for example, one can define three physical spatial regions within the air flow profile 232 where the water injection may occur. With reference to FIG. 32, for example, one may define a central region R_{C} that lies between the radial center V_{L} at axis L and V₁, a middle region R_{MID} that lies between V₁ and V_{MAX}, and an outer region R_{OUT} that lies between V_{MAX} and V_{WALL}.

Within central region R_{C}, the air flow velocity is lower than V_{MAX}. It forms a well such that air flow velocity decreases as one goes from V_{MAX} toward radial center L, reaching a local minimum at or around the radial center or axis L. As the air flow develops along its longitudinal path downstream of the exit plane 214a, the air flow at the outer portions of this region will tend to move inward toward axis L as the faster air in the outer radial areas of this region move past the slower air closer to the center at L.

Within middle region R_{MID}, the air flow velocity is relatively higher than in center region R_{C}, and reaches V_{MAX} at its outer edge. But the air flow velocity similarly increases as one moves outward radially along the air flow velocity profile in this region. Thus, there still will be some tendency for the faster air in outer portions of region R_{MID} to overcome slower air in portions of this region closer to radial center L and therefore move inwardly, especially as the air flow stream develops along its longitudinal path downstream of the exit plane 214a.

Thus, although not necessarily to the same extent, the flow in regions R_{C} and R_{MID} will tend to move inwardly toward axis L as the faster air closer to the outer radial parts of these regions moves past the slower air closer toward the center at L. When balanced against the pressure differential effects between the center of the plume and the air immediately outside the plume, which will tend to cause the plume to diverge outwardly and enlarge with longitudinal distance from the exit plane, these tendencies at least will offset one another.

In contrast, the air flow velocity profile in outer region R_{OUT} has relatively high velocity, including V_{MAX} at its inner edge, but decreases radially throughout the region from V_{MAX} at its inner edge to V_{WALL} in and just downstream of air flow channel 112, and to lower values further downstream of exit plane 114a. Because air flow within outer region R_{OUT} at and near the exit plane 214a will be slower as one moves outward radially from V_{MAX} toward V_{WALL}, air flow in this region will tend to move outward radially as the faster air near V_{MAX} passes the slower moving air near fan casing wall 206b. The pressure differential noted above will tend to add to that outward air flow movement. Accordingly, the air flow emerging from the air flow exit in this region R_{OUT} will tend to expand more quickly and have lower density relative to the air in the center and middle regions R_{C} and R_{MID}.

One may advantageously take these air flow characteristics into account in selecting the water injection location or locations. Bearing in mind that hardware associated with injecting water into the air flow stream, to the extent that it lies physically within the air flow stream, may and likely will have an impact on the air flow velocity profile, and recognizing not only the shape of the velocity profiles at the air flow channel but as the air flow stream moves longitudinally along its path away from the exit plane, one may advantageously select where the water is to be injected and where it will experience the desired mixing of water and air based on such underlying phenomenology.

For example, in view or air flow velocity profile 232, one may choose to position a first set of the water injection positions within center region R_{C} and a second set of water injection positions within middle region R_{MID}, to take advantage of the relatively more favorable mixing environments at those locations relative to outer region R_{OUT} and to mitigate or avoid the more pronounced mixing inefficiencies and water settlement or loss at the plume periphery at outer region R_{OUT}. Given the locations and relative velocity profiles within regions R_{C} and R_{MID}, one may choose, for example, to place a greater number of water injection locations within one of these regions compared to the other, or to inject a greater quantity of water into one of these regions relative to the other.

Similarly, one may treat center region R_{C} and middle region R_{MID} effectively as a single region, e.g., given their common features, and select water injection positions within that combined region. With this arrangement, one may, for example, place the water injection positions within the combined Rc and R_{MID} region so that favorable mixing occurs but so that mixing inefficiencies and water loss in outer region R_{OUT} at the plume periphery are mitigated. Examples of water injection configurations that provide this feature include configuration 154 as shown in FIGS. 8 and 9 and configuration 170 as shown in FIGS. 18-20.

Incidentally, whereas the specific location or line at which the maximum velocity V_{MAX} occurs may require measurement or variation, one may choose to a midpoint V_{MID} in velocity profile 232 as a proxy for V_{MAX}, where midpoint V_{MID} is the line or curve corresponding to the radial midpoint, half the distance radially from longitudinal axis L to wall 206a.

Without mitigating the significance of the foregoing, air velocity profiles and the underlying phenomenology described herein above may vary depending on the specific embodiment, the application, the conditions and so on, and the inventors do not wish to be held to or obligated by any particular theory of operation. From the description herein, however, it will be appreciated that such factors and phenomena such as these may be used advantageously to identify or select water injection locations and design or construct specific embodiments and related methods that can improve or even optimize evaporators and related components, systems and methods according to the various aspects of the invention.

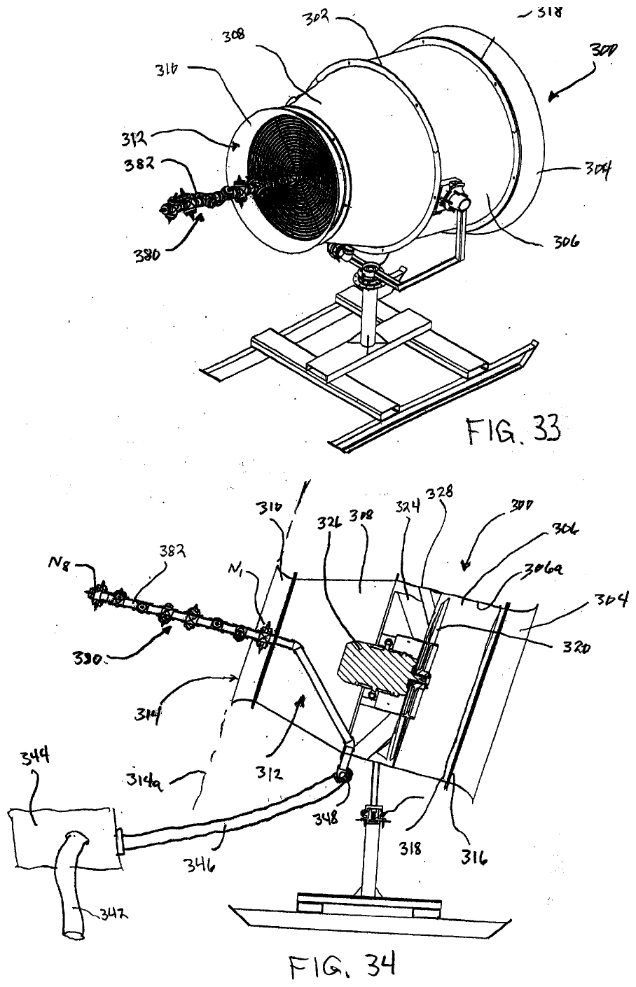

An evaporator 300 according to another presently-preferred embodiment of an aspect of the invention will now be described. Evaporator 300 is shown in perspective view in FIG. 33 and in a side cutaway view FIG. 34. Evaporator 300 is similar if not identical to evaporator 200 as described herein above, but with several exceptions as noted herein. Externally, evaporator 300 looks essentially the same as evaporator 200, for example, as shown in perspective view in FIG. 21. It differs in internal componentry and construction, for example, in that it comprises a modified and improved water injection system.

Evaporator 300 includes a housing 302 which in this embodiment comprises, in order from upstream to downstream, an inlet bell 304, a fan casing 306, an outlet cone 308, and an outlet bell 310. These components comprise a housing air flow channel 312 through which ambient air is transported from upstream to downstream to facilitate the water evaporation. Air flow exit 314 and air flow exit plane 314a are as is described herein above with respect to air flow exit 114 and air flow exit plane 114a.

Evaporator 300 also comprises an air flow induction device that comprises an impeller 320 identical in its design, construction and supporting structure as impeller 220, including guide vanes 224, motor 226 and C-face mount 228, designated for this embodiment as guide vanes 324, motor 326 and C-face mount 328, respectively.

Evaporator 300 also comprises a water provisioning system that injects water from the water body into the air flow stream at a plurality of water injection locations within the air flow stream. The water provisioning system of this embodiment comprises a water feed system 340 as previously described herein above with respect to water feed system 140. The water injection system of this embodiment, however, comprises a highly-efficient device that not only can be incorporated into evaporator 300 and other embodiments, but also may serve as an independent water provisioning or water injection system or system, for example, capable of being adapted or retrofitted to a wide range of evaporators and evaporator designs to improve their efficiency and performance, and thus comprises a separate aspect of the invention.

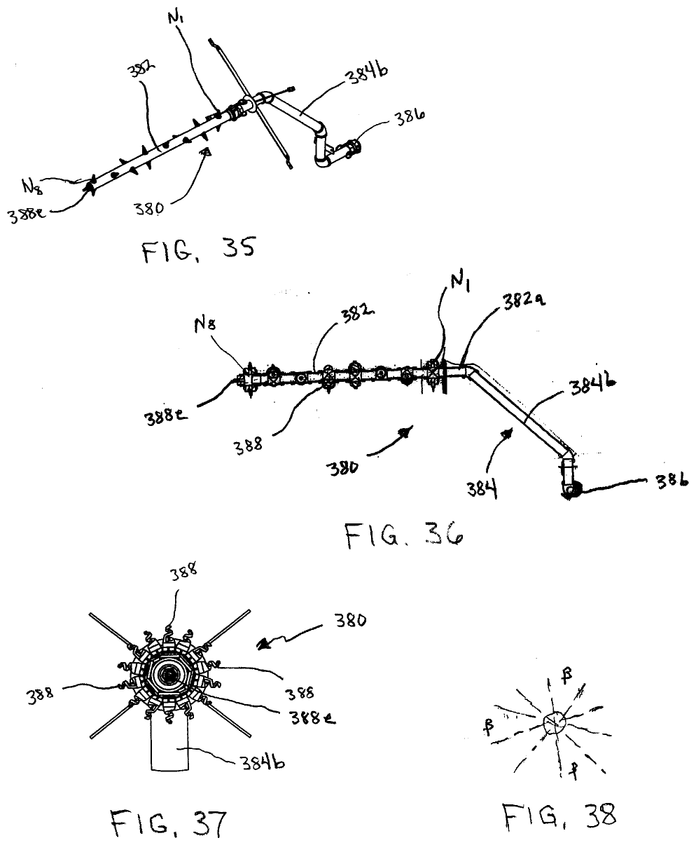

The water provisioning system according to this aspect of the invention, and a separate system, comprises a water injection system 380 which, in evaporator 300, is fluidically coupled to the water feed system and configured to inject water from the water body to a plurality of water injection locations within the air flow stream. Water injection system 380 is shown in FIGS. 33 and 34 coupled to and incorporated into evaporator 300. This same system 380 is shown separately, for example, not only as a component of evaporator 300 but also as a presently-preferred embodiment of an aspect of the invention that could be provided as a separate standalone product, in FIGS. 35-37. FIG. 35 provides a perspective view, FIG. 36 shows a side view, and FIG. 37 shows an end or longitudinal view.

Water injection system 380 includes an elongated substantially linear tubular member, which in this embodiment comprises a pipe manifold 382 disposed longitudinally about a longitudinal axis L of evaporator 300. Pipe manifold 382 comprises a straight or linear pipe constructed of a suitably strong, rigid, water-impermeable and corrosion-resistant material, for example, such as a polyvinyl chloride (“PVC”), stainless steel, aluminum or copper pipe.

Water injection system 380 also comprises a plurality of water injection devices, individually or in one or more nodes, disposed along pipe manifold 382. At least some of these water injection devices and/or nodes are spaced from one another, preferably but optionally with uniform or substantially uniform spacing. As implemented in system 380, the plurality of water injection devices comprises a plurality of water injection nodes Nᵢ, where N reflects a node and “i” designates a specific one of the nodes, i.e., the i^{th} node, in the set of nodes. Optionally but preferably, the water injection system comprises between about two and about ten nodes, but may comprise as many as fifty or more. In system 380, there are eight such nodes, and therefore i=1 through 8 (i.e., N₁, N₂, . . . N₈). In this illustrative embodiment, node N₁ refers to the node furthest upstream and thus closest to the upstream end of air flow channel 312, and the node number or parameter “i” increases sequentially along the downstream length along axis L. The eighth node N₈ is disposed at the downstream end of pipe manifold 382.

The nodes Ni are disposed down the length of pipe manifold 382. Preferably and in this embodiment, the nodes have equal or uniform spacing between them. Although the spacing between adjacent nodes typically will depend on multiple factors, for example, including those described herein, in presently-preferred embodiments the water injection system comprises a longitudinal spacing between adjacent nodes of between at least about 1.5 to 12 inches, and preferably between about 1.5 and 4 inches.

The water injection system according to this aspect further includes hardware or means to provide the water from the water feed system 340, and thus from the water body such as pond 10, to pipe manifold 382 and ultimately to water injection nodes N. This preferably comprises a conduit for fluidically coupling manifold 382 to water feed system 340 to supply water to the manifold, but also a support for physically supporting and positioning the water injection devices and/or nodes within the air flow stream emanating from the air flow channel or channels of the evaporator, preferably along longitudinal axis L.

As implemented in water injection system 380, this comprises a pipe support 384 that serves both of these functions, i.e., pipe support 384 provides mechanical support to rigidly and fixedly position manifold at and along longitudinal axis L of evaporator 300 proximate to the downstream end of air flow channel 312, and also serves to fluidically couple the water feed system 340 to manifold 382. Pipe support 384 is coupled at a first end 384a to housing coupler 348, corresponding to coupler 148 in evaporator 100. Pipe support 384 comprises a pipe section 384b that extends diagonally across a section of air flow channel 312 to a point along longitudinal axis L at which a second end 384c at which pipe section 384b is physically and fluidically coupled with an upstream end 382a of pipe manifold 382.

Each of the nodes Nᵢ in this embodiment comprises at least one, and preferably multiple, water injection devices. In this embodiment 380, each node Ni except the outer-most node (N₈) has two paired and opposing nozzles 388. The outermost node (in this embodiment N₈) comprises a pair of opposed nozzles as described herein, but given its position at the downstream end of pipe manifold 382, it further comprises an additional nozzle 388e at the end of pipe manifold 382 with its principal direction along longitudinal axis L. Each of nozzles 388 is disposed to inject water along its principal direction and outwardly from its position in manifold, i.e., at or immediately proximate to the longitudinal axis L. All of the nozzles 388 except end nozzle 388e is disposed so that its principal direction is radial and thus perpendicular to longitudinal axis. It should be noted that this is not necessarily limiting, and that other angles, or varying angles, besides this radial direction may be employed.

The principal direction of each nozzle in the pair is colinear with the principal direction of the other nozzle, and each nozzle emits a substantially conical water spray along a principal direction that is 180 degrees away from the principal direction of the other nozzle of the pair. In other words, the two nozzles at a given water injection node are directly opposed to one another a spray substantially conical spray patters that are in directly opposite directions. Nozzles 388 are sized and selected to produce water droplets of predetermined size or size range. The type of nozzles and the spray patterns also may be selected based on suitability for the particular embodiment and application. In some applications, for example, the nozzles may be atomizing nozzles and in others simply spray nozzles of suitable water droplet size distribution. Spray geometries other than conical also may be employed.

For each node Ni, the line comprising the principal directions of the respective nozzle pairs is referred to herein as its “node line.” The node line for a given node Nᵢ lies in a node plane that is orthogonal with respect to longitudinal axis L. The respective nodal planes are parallel to one and have the same uniform spacing as the nodes themselves.

Preferably and in this embodiment 380, the node line for a given node and thus for a given pair of nozzles varies from node to node along the length of the manifold, e.g., to reduce or minimize the overlap of water spray from adjacent nodes, as illustrated, for example, in FIGS. 11-13. As shown in FIG. 38, which provides a longitudinal schematic view of pipe manifold 382 looking upstream with the node lines of the various nodes superposed on one another, the angle of the node line for each node Nᵢ with respect to that of its downstream neighboring node Nᵢ₊₁, designated herein as angle β, is the same. This angle of course may vary and ideally will depend on such things as the water injection patterns and characteristics of the water injection devices and nodes.

Ideally when selecting the particulars of the water injection devices and their positioning, one will take into account the objective of limiting or even eliminating overlap between the spray patterns of the water injection devices. Factors that typically may affect the nature and extent of spray overlap may include, for example, the air flow channel geometry, the desired or permissible longitudinal and radial lengths of the air flow stream or plume downstream of the air flow channel exit, the number and positioning of the water injection devices, the water injection pattern of the water injection devices, including the angle β, the velocity and flow rate of the air flow stream, and so on.

More specifically as to water injection system, when addressing a particular application or need, one may balance and select between such factors as the angular node line offset β, the longitudinal spacing of the nodes, the number of nodes, the length of manifold, the spray or atomization pattern of the nozzles, and the anticipated cross-sectional size of the air flow stream at the region of water injection to obtain a water injection pattern that has low water spray or atomization overlap, both radially for a given node and longitudinally for adjacent nodes. One also may wish to select these factors such that the entire 360-degree cross-section of the air flow patter normal to the longitudinal axis has been injected with water.

In presently-preferred embodiments, the angular separation β between each adjacent pair of the water injection devices, as measured by their principal directions, is at least 30 degrees. In this presently-preferred but merely illustrative embodiment 380, the angular spacing β between these adjacent lines preferably is between about 30 and 120 degrees.

The longitudinal position of the water injection nodes or devices for this water injection system may vary from application to application. In evaporator 300, it is positioned so that the first, i.e., most upstream, water injection node N₁, and more specifically the line of principal direction for the nozzles of the first node, lie in or immediately proximate to the exit plane. The remainder of the water injection nodes accordingly are positioned downstream with respect to the first node.

The radial position of the water injection devices and nodes and of the tubular manifold may lie anywhere within the air flow stream, and the factors and considerations described herein above, such as the air flow velocity profile, may be used to select the position or positions. In the presently preferred embodiment, the pipe manifold is disposed along the longitudinal axis L as described above.

The water injection devices of the water injection system may be directed in any of the aforementioned principal directions or directions. In the presently-preferred embodiments, the nozzles are directed radially outward orthogonally with respect to the longitudinal axis and along their respective radial planes, but this is not necessarily limiting. One may, for example, direct the nozzles such that their principal directions are angled in a more downstream direction. The various nozzles also may be disposed in a plurality of directions, for example, to obtain better coverage and to mitigate spray overlap.

Water injection system 380 is advantageous in a number of respects. It can provide water injection within the air flow stream that is centrally located and that provides a maximum spatial margin with respect to the outer periphery of the air flow stream or plume. It can have relatively simple and inexpensive construction, and its simplicity can improve durability and reliability. Water injection system 380 is particularly well suited for use in evaporator 300 and embodiments of its type, for example, in which they have an in-line or longitudinally disposed motor or relatively larger impeller hub and therefore include an air flow velocity profile resembling the toroidal profile of FIGS. 31 and 32. The radially-central longitudinal water injection injects the water into the relatively lower-velocity air flow of the profile. As described herein above, injection in this region of the air flow stream not only avoids the limitations of known devices wherein injection of the water from outside the air flow stream is of more limited effectiveness, but it also takes advantage of the natural air flow characteristics within the air flow stream where the air flow velocity profile has the toroidal-type shape.

The specific configuration of water injection configuration 380 is not necessarily limiting. For example, configurations otherwise identical to configuration 382 but wherein each node Ni includes one nozzle, or three nozzles, or four nozzles may be used instead of the two-nozzle nodes. With a three-nozzle node configuration 386, for example, the node configuration would be identical to configuration 382 but wherein each node N, includes three nozzles. In this configuration, each of the water injection nodes comprises three nozzles or water injection devices lying in a radial plane orthogonal with respect to the longitudinal axis L. Each of the water injection devices of a given node preferably injects the water in a principal direction, and the each of the principal directions is 120 degrees from the other two principal directions.

If a configuration with four nozzles per node is used, preferably in which the principal directions of each nozzle in a given node lies in a radial plane orthogonal with respect to the longitudinal axis, each of the nozzles or water injection devices injects the water so that each of the principal directions is 90 degrees from each of two adjacent principal directions.

With respect to the various motors described herein, in many applications they may comprise any motor design or configuration that is suitable for performing the function they are to perform as described herein, for example, such as driving a fan or impeller and powering a pump. Examples of suitable designs would include electric motors, pneumatic motors, hydraulic motors, and so on. In presently-preferred embodiments, the motors comprise electric AC induction motors of suitable size and power rating. Given the aqueous environment in which evaporators operate, suitably designed and rated motors would be required. Where flammable or hazardous fluids are involved, motors rated for those environments would be required.

Each of the motors described herein require a power supply to power the motor, and therefore a suitable power supply would be required. In presently-preferred embodiments, a standard shore-based electrical power supply would be provided to power the motor or motors via a water use-qualified transmission cable. A power switch to turn the power on and off may be positioned at evaporator 100 or at the shore power source or both. Preferably, for ease of access and use, the power switch in this embodiment is located at the shore-based power source.

Presently-preferred evaporators, systems and methods for evaporating water from a water body as disclosed herein have been described as comprising an electric motor that drives an impeller to move air through the housing air flow channel and float channels. In many practical applications, the load on the motor is not uniform. Moreover, in many applications it is desirable or even necessary to adjust the air flow parameters, for example, such as the air flow velocity, the volumetric flow rate, and so on. Operating the impeller or other air flow induction device using an electric motor often can be done more efficiently or even optimally by adjusting the operational characteristics of the motor, such as torque and rotational speed. Evaporators and related systems and methods thus may comprise a variable power or variable speed controller. Examples of variable power or variable speed controllers may include rheostats, L-pads, motor speed control boxes, mechanical variable speed transmissions, variable speed or variable frequency drives, voltage controllers, current controllers, digital controllers and other means known in the motor industry.

Further details and preferred embodiments of variable speed and power controls and related systems and methods are disclosed and shown in commonly-owned and assigned U.S. Provisional Patent Application No. 62/656,887, incorporated herein by reference as indicate herein above.

Having described multiple illustrative presently-preferred embodiments, systems and method implementations, one of ordinary skill in the art will appreciate that certain variations and modifications may be made relative to the specific embodiments and methods expressly provided herein. Additional advantages and modifications will readily occur to those skilled in the art. Therefore, the invention in its broader aspects is not limited to the specific details, representative devices and methods, and illustrative examples shown and described. Accordingly, departures may be made from such details without departing from the spirit or scope of the general inventive concept as defined by the appended claims and their equivalents.

1. An evaporator for evaporating water from an ambient water body, the evaporator comprising:
a housing comprising an air flow channel and an air flow exit;
an air flow induction device that facilitates the directing of an air flow stream through the air flow channel and out the air flow exit; and
a water injection device in fluid communication with the air flow channel and disposed to inject the water from the water body into the air flow stream at a water injection location within the air flow stream and proximate to the air flow exit.

2. An evaporator as recited in claim 1, wherein:
the air flow channel is disposed longitudinally about a longitudinal axis; and
the water injection location comprises a location at the longitudinal axis. (current or preferred location of the Lance)

3. An evaporator as recited in claim 1, wherein:
the air flow channel is disposed longitudinally about a longitudinal axis; and
the water injection location comprises a location that is spaced radially from the longitudinal axis.
the air flow channel comprises an air flow exit having a radius R normal to the longitudinal axis; and
the radially spaced location is spaced between within about 75% of the radius R relative to the longitudinal axis.

4. An evaporator as recited in claim 1, wherein:
the air flow channel is disposed longitudinally about a longitudinal axis; the air flow channel provides the air stream to have an air flow velocity profile having a maximum velocity location; and
the water injection location is disposed within a region lying between the longitudinal axis and the maximum velocity location.

5. An evaporator as recited in claim 1, wherein;
the air flow channel is disposed longitudinally about a longitudinal axis; and
the water injection location is disposed at a midpoint between the longitudinal axis and a wall of the air flow channel.

6. An evaporator as recited in claim 1, wherein water injection device injects the water into the air flow stream at a plurality of water injection locations.

7. An evaporator as recited in claim 6, wherein the respective water injection locations are spaced from one another.

8. An evaporator as recited in claim 6, wherein:
the air flow channel is disposed about a longitudinal axis; and the water injection locations are spaced from one another along the longitudinal axis.

9. An evaporator as recited in claim 6, wherein:
the air flow channel is disposed in a plurality of radial planes orthogonal with respect to a longitudinal axis; and
the water injection locations are spaced from one another in the radial planes.

10. An evaporator as recited in claim 6, wherein:
a first set of the plurality of water injection devices injects water in a first principal direction; and
a second set of the plurality of water injection devices injects water in a second principal direction.

11. An evaporator as recited in claim 10, wherein the first principal direction has an angle of about 30 to 90 degrees with respect to the second principal direction.

12. An evaporator as recited in claim 6, wherein:
the air flow channel is disposed about a longitudinal axis;
the plurality of water injection devices comprises n water injection devices disposed longitudinally, where n is a variable that may assume an integer value greater than 1, each of the n water injection devices comprising a principal direction;
for each adjacent pair of the water injection devices, the principal directions having an angular separation of at least 30 degrees.

13. A method for evaporating water from an ambient body of water using an evaporator comprising an air flow channel and an air flow exit, the method comprising: directing an air flow stream through the air flow channel and out the air flow exit; and injecting the water into the air flow stream at a water injection location within the air flow stream proximate to the air flow exit.

14. A method as recited in claim 13, wherein the provision of an air stream through the air flow channel comprises using an impeller that consists essentially of a fiberglass material.

15. A method as recited in claim 13, wherein:
the provision of an air stream through the air flow channel comprises reducing non-longitudinal air flow within the air flow channel; and
the reducing of the non-longitudinal air flow within the air flow channel comprises using a plurality of guide vanes disposed within the air flow channel

16. A method as recited in claim 13, wherein:
the air flow channel is disposed longitudinally about a longitudinal axis;
the water injection location comprises a location that is spaced radially from the longitudinal axis.
the air flow channel comprises an air flow exit having a radius R normal to the longitudinal axis; and
the radially spaced location is spaced between about 0% and about 75% of the radius R relative to the longitudinal axis.

17. A method as recited in claim 13, wherein:
the air flow channel is disposed longitudinally about a longitudinal axis;
the providing of the air stream through the air flow channel comprises providing the air stream to have an air flow velocity profile having a maximum velocity location; and
the water injection location is disposed within a region lying between the longitudinal axis and the maximum velocity location.

18. A method as recited in claim 13, wherein:
the air flow channel is disposed about a longitudinal axis;
the injecting of the water at the plurality of water injection locations comprises spacing the respective water injection locations from one another along the longitudinal axis; and
the spacing of the respective water injection locations from one another along the longitudinal axis comprises disposing paired water injection locations so that the water injection from one of the paired water injection locations does not overlap with the water injection from the other of the paired water injection locations.

19. A method for evaporating water from an ambient body of water using an evaporator comprising an air flow channel and an air flow exit disposed about a longitudinal axis, the method comprising:
directing an air flow stream through the air flow channel and out the air flow exit;
disposing at least one water injection device at a water injection location within the air flow stream proximate to the air flow exit; and
injecting the water into the air flow stream using the at least one water injection device.

20. A water injection system for injecting water from an ambient water body into an air flow stream directed by an air flow channel of an evaporator, the air flow channel being disposed about a longitudinal axis, the water injection system comprising:
an elongated tubular member disposed parallel with respect to the longitudinal axis;
a plurality of water injection nodes disposed at the tubular member and being spaced from one another longitudinally; and
a support for positioning the elongated tubular member within or proximate to the air flow channel so that the plurality of water injection nodes are positioned within the air flow stream.

21. An evaporator for evaporating water from an ambient water body, the evaporator comprising:
a housing comprising an air flow channel and an air flow exit disposed about a longitudinal axis, wherein the air flow channel provides an air flow stream through the air flow channel and out the air flow exit in a downstream direction; and
a water injection system that injects the water into the air flow stream, the water injection system comprising
an elongated manifold disposed along the longitudinal axis within the air flow stream,
a plurality of water injection nodes disposed at the manifold, the water injection nodes being spaced from one another in the downstream direction,
each water injection node comprising at least one water injection device that injects the water into the air flow stream at a water injection location within the air flow stream proximate to the air flow exit.
